(19) United States
(12) Patent Application Publication
(10) Pub. No.: US 2019/0299826 A1
(43) Pub. Date: Oct. 3, 2019

(54) SEAT AIR CONDITIONER

(71) Applicant: DENSO CORPORATION, Kariya-city (JP)

(72) Inventors: Takahisa FUJII, Kariya-city (JP); Hideaki KAKO, Kariya-city (JP); Hironobu MURAKAMI, Kariya-city (JP); Masafumi KAWASHIMA, Kariya-city (JP); Shuji ITO, Kariya-city (JP)

(21) Appl. No.: 16/444,353

(22) Filed: Jun. 18, 2019

Related U.S. Application Data
(63) Continuation of application No. PCT/JP2017/046012, filed on Dec. 21, 2017.

(30) Foreign Application Priority Data
Jan. 24, 2017 (JP) 2017-010488
Nov. 16, 2017 (JP) 2017-221168

(51) Int. Cl. B60N 2/56; B60H 1/00; B60N 2/64

(52) U.S. Cl. CPC B60N 2/5657; B60N 2/646; B60N 2/5642; B60H 1/00285

(57) ABSTRACT

A seat air conditioner includes a ventilation passage member disposed on a surface of a seat cushion and configured to form an air flow passage through which an air flows in a predetermined direction along the surface. The ventilation passage member includes a first ventilation port and a second ventilation port through which an inside of the air flow passage communicates with outside of the air flow passage. The ventilation passage member is provided to close communication between the inside and outside of the air flow passage, over an entire region of the ventilation passage member between the first ventilation port and the second ventilation port in the predetermined direction.

### CROSS REFERENCE TO RELATED APPLICATIONS

The present application is a continuation application of International Patent Application No. PCT/JP2017/046012 filed on Dec. 21, 2017, which designated the United States and claims the benefit of priority from Japanese Patent Applications No. 2017-010488 filed on Jan. 24, 2017 and No. 2017-221168 filed on Nov. 16, 2017. The entire disclosures of all of the above applications are incorporated herein by reference.

### TECHNICAL FIELD

The present disclosure relates to a seat air conditioner.

### BACKGROUND

Conventionally, one type of vehicle seat air conditioner includes: a ventilation passage member that has a plurality of tubes arranged and integrated in a vehicle width direction, each tube constituting an air flow passage extending in the vehicle traveling direction; and a blower connected to a rear side in the vehicle traveling direction of the plurality of tubes to generate an airflow which circulates through the tubes.

The ventilation passage member is disposed on a surface of a seat cushion in a vehicle seat that supports the thighs and buttocks of a user. The ventilation passage member is provided with a plurality of ventilation ports that communicate with the respective plurality of tubes and extend in the vehicle width direction.

### SUMMARY

According to an aspect of the present disclosure, a seat air conditioner to be used for a seat includes a ventilation passage member having a first ventilation port and a second ventilation port that are configured to communicate between an inside and an outside of an air flow passage of the ventilation passage member. The first ventilation port and the second ventilation port are arranged in positions within the ventilation passage member, avoiding a seating portion that mainly supports the buttocks or the back of a user when the user sits on the seat. The ventilation passage member may be provided on a seating portion of the seat or a back portion of the seat.

The ventilation passage member may be configured to close the air flow passage, over an entire region of the ventilation passage member between the first ventilation port and the second ventilation port. Alternatively, the ventilation passage member located between the first ventilation port and the second ventilation port may be not provided with a ventilation port through which the air is blown from the air flow passage to the user or to draw the air flowing from the side of the user into the air flow passage.

### BRIEF DESCRIPTION OF DRAWINGS

FIG. 1A is a diagram showing a cross-sectional configuration of a vehicle seat in a first embodiment;

FIG. 1B is a diagram showing a ventilation passage member in a state where a cover of the vehicle seat is removed, as viewed from an arrow IB in FIG. 1A in the first embodiment;

FIG. 1C is a diagram showing seat cushion states, wherein (a) shows a state in which a seating pressure is not applied to a seat cushion in a first comparative example, which includes the seat cushion forming a plurality of air passages by a three-dimensional fabric, instead of the ventilation passage member including a plurality of tubes, and (b) shows a state in which a seating pressure is applied to the seat cushion in the first comparative example;

FIG. 1D is a diagram showing a plurality of tubes of the ventilation passage member in the first embodiment, wherein (a) shows a state in which no seating pressure is applied to the plurality of tubes of the ventilation passage member in the first embodiment, and (b) shows a state in which any seating pressure is applied to the plurality of tubes of the ventilation passage member in the first embodiment;

FIG. 2 is a diagram showing a ventilation passage member in a state where a cover of the vehicle seat is removed in a second embodiment and corresponding to FIG. 1B;

FIG. 3A is a diagram showing a cross-sectional configuration of a vehicle seat in a third embodiment;

FIG. 3B is a diagram showing a ventilation passage member in a state where a cover of the vehicle seat is removed, as viewed from an arrow IIIB in FIG. 3A in the third embodiment;

FIG. 4 is an enlarged diagram of only an upper side ventilation port and a lower side ventilation port of the ventilation passage member in the third embodiment;

FIG. 5 is a diagram showing a ventilation passage member in a state where a cover of the vehicle seat is removed in a fourth embodiment and corresponding to FIG. 1B;

FIG. 6A is a diagram showing a cross-sectional configuration of a vehicle seat in a fifth embodiment;

FIG. 6B is a diagram showing a ventilation passage member in a state where a cover of the vehicle seat is removed, as viewed from an arrow VIB in FIG. 6A in the fifth embodiment;

FIG. 6C is a cross-sectional view taken along the line VIC-VIC in FIG. 6B in the fifth embodiment;

FIG. 7A is a diagram showing a cross-sectional configuration of a vehicle seat in a sixth embodiment;

FIG. 7B is a diagram showing a ventilation passage member in a state where a cover of the vehicle seat is removed, as viewed from an arrow VIIB in FIG. 7A in the sixth embodiment;

FIG. 8A is a diagram showing a cross-sectional configuration of a vehicle seat in a seventh embodiment;

FIG. 8B is a diagram showing a ventilation passage member in a state where a cover of the vehicle seat is removed, as viewed from an arrow VIIIB in FIG. 8A in the seventh embodiment;

FIG. 8C is a cross-sectional view taken along the line VIIIC-VIIIC in FIG. 8A in the seventh embodiment;

FIG. 9A is a diagram showing a cross-sectional configuration of a vehicle seat in an eighth embodiment;

FIG. 9B is a diagram showing a ventilation passage member in a state where a cover of the vehicle seat is removed, as viewed from an arrow IX in FIG. 9A in the eighth embodiment;

FIG. 10 is a diagram showing a ventilation passage member in a state where a cover of the vehicle seat is removed in a ninth embodiment and corresponding to FIG. 2;

FIG. 11 is a diagram showing a ventilation passage member in a state where a cover of the vehicle seat is removed in a tenth embodiment and corresponding to FIG. 5; and

FIG. 12 is a diagram showing a seat cushion and a ventilation passage member in a state where a cover of the vehicle seat is removed in a second comparative example.

### DESCRIPTION OF EMBODIMENTS

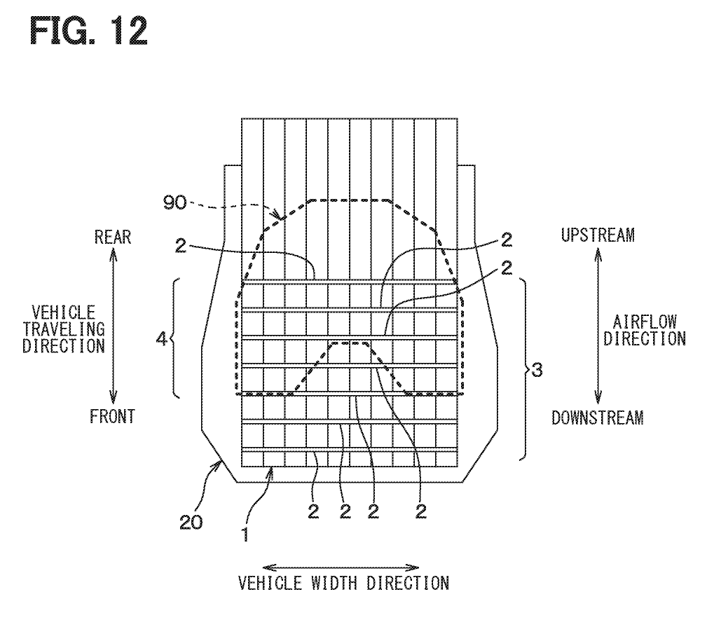

The inventors of the present applicant have studied about a ventilation passage member 1 that has a plurality of ventilation ports 2 distributed in a vehicle traveling direction, in a vehicle seat air conditioner shown in FIG. 12.

Airflow fed from a blower through the ventilation passage member can be blown out of the plurality of ventilation ports 2 into the interior of a vehicle cabin. In this case, an area around the thighs and buttocks of a user can be air-conditioned with the airflow passing through the plurality of ventilation ports 2 of the seat cushion.

According to the studies by the inventors of the present applicant, a ventilation port forming portion 3 that forms the plurality of ventilation ports 2 in the ventilation passage member 1 has a lower rigidity than other portions of the ventilation passage member 1 where no ventilation port 2 is formed.

Therefore, when any pressure is applied from the thighs and buttocks of the user sitting on the seat to the ventilation port forming portion 3, a part of the ventilation port forming portion 3 with the pressure applied from the thighs and buttocks of the user (hereinafter referred to as a pressurized portion 4) may be elastically deformed and collapsed in some cases. In this case, air passages located in the pressurized portion 4 are closed to stop the airflow blown by the blower from spreading over the airflow downstream side (i.e., the front side in the vehicle traveling direction) of the ventilation passage member 1 with respect to the pressurized portion 4.

Thus, some of the plurality of ventilation ports 2 located on the airflow downstream side (i.e., the front side in the vehicle traveling direction) of the pressurized portion 4 do not blow out any airflow toward the user. Consequently, the user would feel less comfortable.

In a vehicle seat air conditioner, air is not blown from a blower to the interior of the vehicle cabin through the ventilation passage member 1, but air drawn through the plurality of ventilation ports 2 is drawn into the blower through the ventilation passage member 1.

In this case, the pressurized portion 4 of the plurality of ventilation ports 2 in the ventilation passage member 1 is elastically deformed and collapsed by being pressurized by the thighs or buttocks of the user. In this case, although the blower operates, the airflow cannot be drawn from the ventilation ports 2 of the ventilation passage member 1 located on the front side in the vehicle traveling direction with respect to the pressurized portion 4. Consequently, the user would feel less comfortable.

The present disclosure relates to a seat air conditioner which can provide comfortable feeling for a user seated on a seat.

Hereinafter, embodiments of the present disclosure will be described with reference to the accompanying drawings. In the following respective embodiments, portions that are the same or equivalent to each other are denoted by the same reference numerals in the drawings to simplify the description thereof.

### First Embodiment

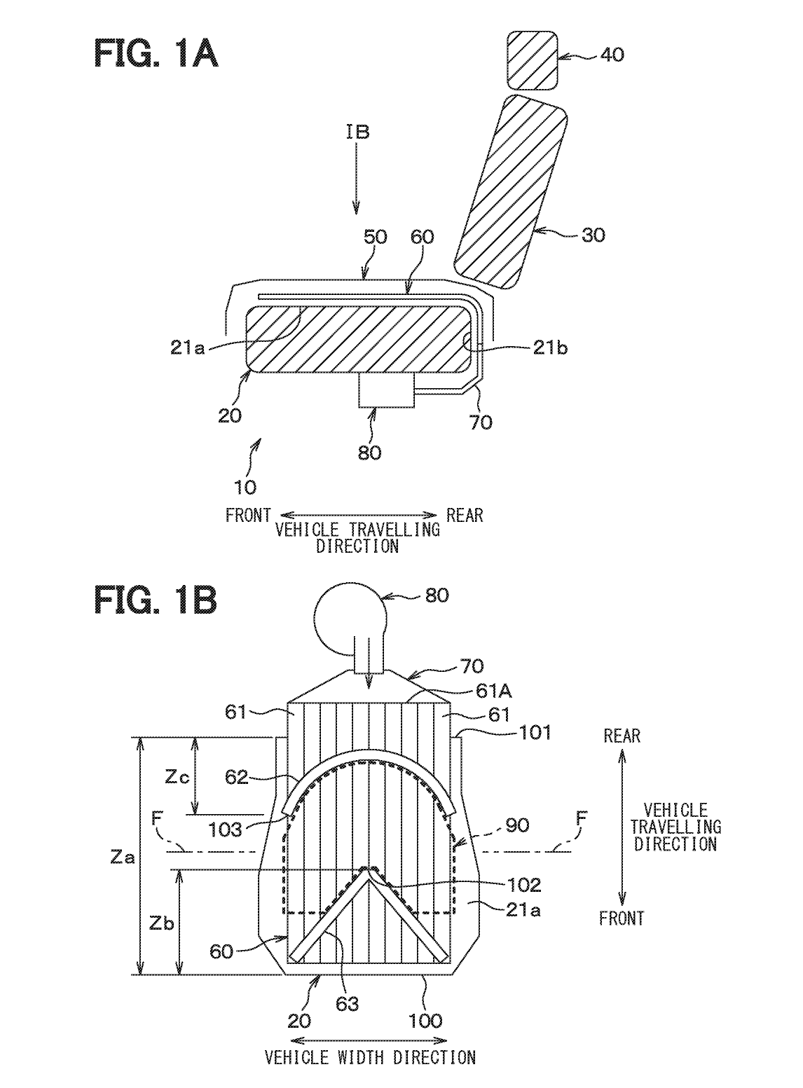

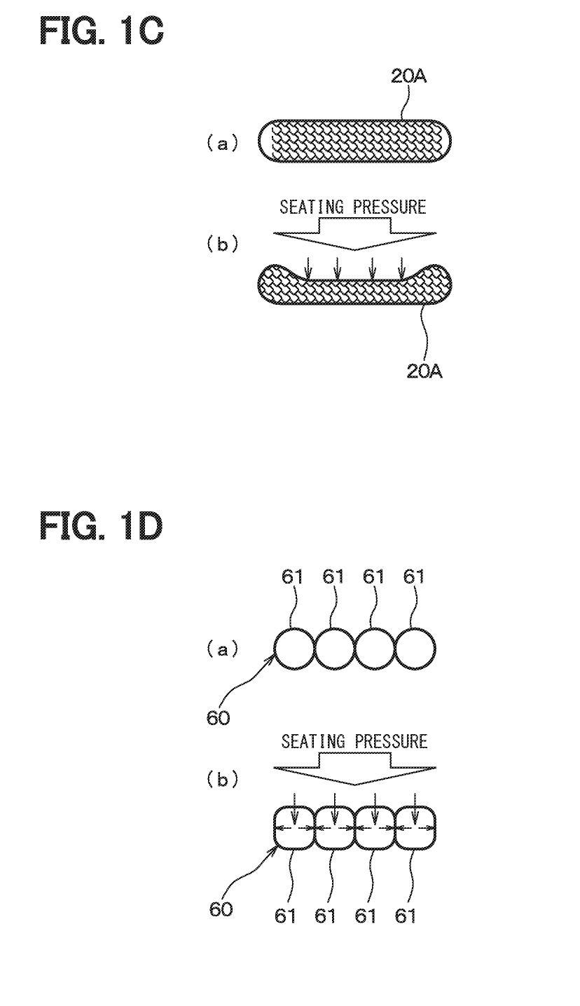

FIGS. 1A to 1D show a first embodiment of a seat 10 of a vehicle in which a seat air conditioner of the present disclosure is used.

As shown in FIGS. 1A and 1B, the seat 10 of the vehicle includes a seat cushion 20, a seat back 30, a headrest 40, a cover 50, a ventilation passage member 60, a connecting portion 70, and an electric blower 80.

The seat cushion 20 supports the thighs and buttocks of a user (i.e., an occupant) and is constituted of a seat pat that is elastically deformed while supporting the occupant on the side of a surface 21a.

The seat back 30 supports the back of the occupant and is constituted of a seat pat that is elastically deformed while supporting the occupant on the surface side. The headrest 40 supports the head of the occupant.

The seat cushion 20, the seat back 30, and the headrest 40 of the present embodiment are supported by a seat frame or the like such that the user is directed forward in the vehicle traveling direction while being seated. The seat frame is a member that constitutes the skeleton of the seat. The seat cushion 20 or the seat pad constituting the seat back 30 is made of an elastic member, such as urethane foam.

The cover 50 is a sheet of a nonwoven fabric or the like, which has air permeability. The cover 50 is disposed so as to cover the surface 21a of the seat cushion 20.

The ventilation passage member 60 is disposed between the seat cushion 20 and the cover 50. The ventilation passage member 60 is provided along the surface 21a and a side wall 21b of the seat cushion 20.

The ventilation passage member 60 is formed in a sheet shape by integrally arranging a plurality of tubes 61 such that the tubes are adjacent to each other in the vehicle width direction. Each of the plurality of tubes 61 forms an air flow passage through which the airflow circulates to the front side in the vehicle traveling direction along the surface 21a of the seat cushion 20.

The direction in which the airflow flows through the ventilation passage member 60 of the present embodiment is a predetermined direction intersecting (for example, orthogonal to) the vehicle width direction.

The ventilation passage member 60 is configured to be elastically deformable by a pressure applied from the buttocks of the user (i.e., seating pressure).

The ventilation passage member 60 is provided with an air inlet 61A where the airflow blown from the electric blower 80 enters. The air inlet 61A is formed to be open on the rear side in the vehicle traveling direction of the ventilation passage member 60. The air inlet 61 A is constituted of air inlets of the respective plurality of tubes 61.

The ventilation passage member 60 is provided with a rear side ventilation port 62 and a front side ventilation port 63 which are open on the side of the cover 50. The rear side ventilation port 62 is configured by arranging communication holes that communicate between the inside and the outside of each of the plurality of tubes 61.

The rear side ventilation port 62 is formed in a U shape that is convex rearward in the vehicle traveling direction. Specifically, the rear side ventilation port 62 is formed in the U shape that extends forward in the vehicle traveling direction, from the center in the vehicle width direction toward one side in the vehicle width direction of the ventilation passage member 60, and also extends forward in the vehicle traveling direction, from the center in the vehicle width direction toward the other side in the vehicle width direction of the ventilation passage member 60. Consequently, the rear side ventilation port 62 is formed along the contour of the buttocks of the seated occupant.

The front side ventilation port 63 is formed in a V shape that is convex rearward in the vehicle traveling direction. Specifically, the front side ventilation port 63 is formed in the V shape that extends forward in the vehicle traveling direction, from the center in the vehicle width direction toward one side in the vehicle width direction of the ventilation passage member 60, and also extends forward in the vehicle traveling direction from the center in the vehicle width direction toward the other side in the vehicle width direction of the ventilation passage member 60. Consequently, the front side ventilation port 63 is formed along the inner crotch of the seated occupant.

A center line F is defined as an imaginary line that extends in the vehicle width direction orthogonal to the vehicle traveling direction while passing through the midpoint in the vehicle traveling direction of the surface 21a of the seat cushion 20.

In other words, a first distance is defined as a distance between the center line F and a front end 100 in the vehicle traveling direction of the surface 21a of the seat cushion 20. A second distance is defined as a distance between the center line F and a rear end 101 in the vehicle traveling direction of the surface 21a of the seat cushion 20. Thus, the central line F is an imaginary line set so that the first distance and the second distance are the same.

The rear side ventilation port 62 is located on the rear side in the vehicle traveling direction of the ventilation passage member 60 with respect to the center line F. That is, the rear side ventilation port 62 is disposed in a portion, which avoids a seating portion 90, within the ventilation passage member 60.

The seating portion 90 is a portion of the surface 21a of the seat cushion 20 that mainly supports the buttocks of the user, i.e., a portion of the seat cushion 20 that mainly receives the pressure from the buttocks of the user.

The front side ventilation port 63 is located on the front side in the vehicle traveling direction of the ventilation passage member 60 with respect to the center line F. That is, the front side ventilation port 63 is disposed in a portion, which avoids the seating portion 90, within the ventilation passage member 60.

Consequently, the rear side ventilation port 62 and the front side ventilation port 63 are disposed such that the seating portion 90 overlaps with a portion of the ventilation passage member 60 located between the rear side ventilation port 62 and the front side ventilation port 63. That is, the front side ventilation port 63 is disposed on the front side in the vehicle traveling direction with respect to the seating portion 90. The rear side ventilation port 62 is disposed on the rear side in the vehicle traveling direction with respect to the seating portion 90.

The ventilation passage member 60 functions to circulate an airflow supplied from the electric blower 80 through the connecting portion 70 into the plurality of tubes and to blow out the airflow from each of the rear side ventilation port 62 and the front side ventilation port 63 into the interior of the vehicle cabin.

The plurality of tubes 61 constituting the ventilation passage member 60 of the present embodiment are made of a resin material, such as a thermoplastic elastomer.

The plurality of tubes of the ventilation passage member 60 are formed such that the other portions of the ventilation passage member 60 configured in this way, except for the rear side ventilation port 62, the front side ventilation port 63, and the air inlet 61A, entirely close the area between the inside and outside of each of the plurality of air flow passages.

Specifically, the plurality of tubes of the ventilation passage member 60 are formed so as to close the area between the inside and outside of each of the plurality of air flow passages, over an entire region of the ventilation passage member 60 between the rear side ventilation port 62 and the front side ventilation port 63.

The plurality of tubes of the ventilation passage member 60 are formed such that the other portion of the ventilation passage member 60, except for the air inlet 61A, located on the rear side in the vehicle traveling direction with respect to the rear side ventilation port 62 entirely closes the corresponding area between the inside and outside of each of the plurality of air flow passages.

The plurality of tubes of the ventilation passage member 60 are formed such that the portion of the ventilation passage member 60 located on the front side in the vehicle traveling direction with respect to the front side ventilation port 63 entirely closes the corresponding area between the inside and outside of each of the plurality of air flow passages.

An air inlet of the connecting portion 70 is connected to an air outlet of the electric blower 80. An air outlet of the connecting portion 70 is connected to the air inlet 61A of the ventilation passage member 60.

That is, the connecting portion 70 is a duct that is disposed between the electric blower 80 and the plurality of tubes 61 of the ventilation passage member 60 and constitutes an air flow passage for distributing the airflow from the electric blower 80 to the plurality of tubes 61 of the ventilation passage member 60.

The connecting portion 70 of the present embodiment is a pipe made of a resin material, such as vinyl and rubber.

The electric blower 80 includes a centrifugal fan, an electric motor for driving the centrifugal fan, and the like. The electric blower 80 draws an airflow in the interior of the vehicle cabin and blows the airflow toward the plurality of tubes 61 of the ventilation passage member 60 through the connecting portion 70. The electric blower 80 of the present embodiment is disposed on the back side of the seat cushion 20. The ventilation passage member 60, the connecting portion 70, and the electric blower 80 of the present embodiment constitute the vehicle seat air conditioner.

Next, the operation of the vehicle seat air conditioner of the present embodiment will be described.

When electric power is supplied to the electric blower 80, the electric blower 80 draws an airflow from the interior of the vehicle cabin to blow out the airflow to the connecting portion 70. Then, the connecting portion 70 divides the airflow blown from the electric blower 80 to supply the divided airflows to the plurality of tubes 61.

Here, the plurality of tubes 61 of the ventilation passage member 60 are formed so as to close the area between the inside and outside of each of the plurality of air flow passages, over the entire region of the ventilation passage member 60 between the rear side ventilation port 62 and the front side ventilation port 63.

Alternately, a seat cushion 20A which has therein a plurality of air flow passages formed of a three-dimensional fabric is used, in place of the ventilation passage member 60, as follows. That is, when the occupant is seated, the seat cushion 20A receives any pressure from the buttocks of the occupant to reduce the cross-sectional region of the air flow passage, as shown in FIG. 1C.

In contrast, the ventilation passage member 60 of the present embodiment is formed in a sheet shape by integrally arranging a plurality of tubes 61 such that the tubes are adjacent to each other in the vehicle width direction. Thus, the plurality of air flow passages are formed to circulate the airflow along the surface 21a of the seat cushion 20. In addition, the plurality of tubes 61 of the ventilation passage member 60 are formed so as to close the area between the inside and outside of each of the plurality of air flow passages, over the entire region of the ventilation passage member 60 between the rear side ventilation port 62 and the front side ventilation port 63.

That is, between the rear side ventilation port 62 and the front side ventilation port 63 in the ventilation passage member 60, no ventilation port is provided for blowing the airflow from the air flow passage of each tube 61 to the occupant or for drawing the airflow from the occupant side into the air flow passage of each tube 61.

Thus, when the user sits on the seat 10, the region of the ventilation passage member 60 between the rear side ventilation port 62 and the front side ventilation port 63 is elastically deformed by the pressure (seating pressure) applied from the buttocks of the user. However, as shown in FIG. 1D, two adjacent tubes 61 of the plurality of tubes 61 support each other. Thus, each of the plurality of tubes 61 maintains its air flow passage for each tube 61 without being collapsed.

Therefore, the airflow supplied from the electric blower 80 to each of the plurality of tubes 61 through the connecting portion 70 passes through the seating portion 90 of the plurality of tubes 61 to flow to the side of the front side ventilation port 63. Consequently, the airflow is blown from each of the rear side ventilation port 62 and the front side ventilation port 63 of the ventilation passage member 60 to the buttocks, thighs, and the like of the occupant through the plurality of fine holes in the cover 50.

According to the present embodiment descried above, the vehicle seat air conditioner is used in the seat 10 that includes the seat cushion 20 for supporting the thighs and buttocks of the user on its surface 21a.

The vehicle seat air conditioner includes the ventilation passage member 60 that is disposed on the surface 21a of the seat cushion 20, elastically deformed by the pressure applied from the buttocks of the user, and has the plurality of tubes 61 respectively forming the air flow passages for circulating the airflow to the front side in the vehicle traveling direction.

The ventilation passage member 60 forms therein the rear side ventilation port 62 and the front side ventilation port 63 each of which communicates between the inside and outside of each air flow passage.

The rear side ventilation port 62 and the front side ventilation port 63 are disposed in positions, which avoid the seating portion 90, within the ventilation passage member 60. The seating portion 90 is a portion of the surface 21a of the seat cushion 20 that mainly supports the buttocks of the user.

The front side ventilation port 63 is located on the front side in the vehicle traveling direction of the ventilation passage member 60 with respect to the center line F. The rear side ventilation port 62 is located on the other side in the vehicle traveling direction of the ventilation passage member 60 with respect to the center line F.

The ventilation passage member 60 is formed so as to close the area between the inside and outside of each of the plurality of air flow passages, over the entire region of the ventilation passage member 60 between the rear side ventilation port 62 and the front side ventilation port 63.

Therefore, the two adjacent tubes 61 of the plurality of tubes 61 support each other in the ventilation passage member 60, even when any pressure is applied from the thighs or buttocks of the user to the region between the rear side ventilation port 62 and the front side ventilation port 63 in the ventilation passage member 60.

Thus, the region between the rear side ventilation port 62 and the front side ventilation port 63 in the ventilation passage member 60 is prevented from being collapsed due to its elastic deformation. Consequently, the airflow can be blown out of each of the rear side ventilation port 62 and the front side ventilation port 63. Therefore, the seat air conditioner can be provided which prevents the user from feeling less comfortable.

In the present embodiment, the front side ventilation port 63 is formed in the V shape that is convex rearward in the vehicle traveling direction. Consequently, the airflow from the front side ventilation port 63 can be blown out along the inner crotch of the user. Thus, the user can feel more comfortable.

In the present embodiment, the rear side ventilation port 62 is formed in the U shape that is convex rearward in the vehicle traveling direction. Consequently, the airflow from the rear side ventilation port 62 can be blown out along the outline of the buttocks of the user. Thus, the user can feel more comfortable.

In the present embodiment, the plurality of tubes of the ventilation passage member 60 are formed such that the other portions of the ventilation passage member 60, except for the rear side ventilation port 62, the front side ventilation port 63, and the air inlet 61A, entirely close the area between the inside and outside of each of the plurality of air flow passages.

Thus, the amount of air blown out of the rear side ventilation port 62 and the front side ventilation port 63 can be ensured.

Next, referring to FIG. 1B, a description will be given on the positional relationship between the front side ventilation port 63 and the rear side ventilation port 62 with respect to the surface 21a of the seat cushion 20 in the present embodiment.

A dimension Za is defined as a distance between the front end 100 in the vehicle traveling direction and the rear end 101 in the vehicle traveling direction at the surface 21a of the seat cushion 20.

A dimension Zb is defined as a distance between the front end 100 in the vehicle traveling direction of the surface 21a of the seat cushion 20 and a rear side 102 in the vehicle traveling direction of the front side ventilation port 63.

The front side ventilation port 63 is formed such that Wx is 40% or less, where Wx (=Zb/Za) is a ratio of the dimension Zb to the dimension Za in percentage on the assumption that the dimension Za is 100%.

A dimension Zc is defined as a distance between the rear end 101 in the vehicle traveling direction of the surface 21a of the seat cushion 20 and a front side 103 in the vehicle traveling direction of the rear side ventilation port 62.

The rear side ventilation port 62 is formed such that Wy is 30% or less, where Wy (=Zc/Za) is a ratio of the dimension Zc to the dimension Za in percentage on the assumption that the dimension Za is 100%.

Alternatively, the front side ventilation port 63 is formed such that Wx is 30% or less, whereas the rear side ventilation port 62 is formed such that Wy is 20% or less.

The rear side ventilation port 62 and the front side ventilation port 63 are formed so as to achieve such Wx and Wy. For this reason, the rear side ventilation port 62 is disposed on the rear side in the vehicle traveling direction of the seat cushion 20 with respect to a portion of the seat cushion 20 which the occupant is in contact with, whereas the front side ventilation port 63 is disposed on the front side in the vehicle traveling direction with respect to a portion of the seat cushion 20 which the occupant is in contact with.

With the above-mentioned configuration, the waist portion or the like of the occupant is placed between the rear side ventilation port 62 and the front side ventilation port 63 of the seat cushion 20, so that the rear side ventilation port 62 and the front side ventilation port 63 can be prevented from being closed by a portion of the body of the occupant.

### Second Embodiment

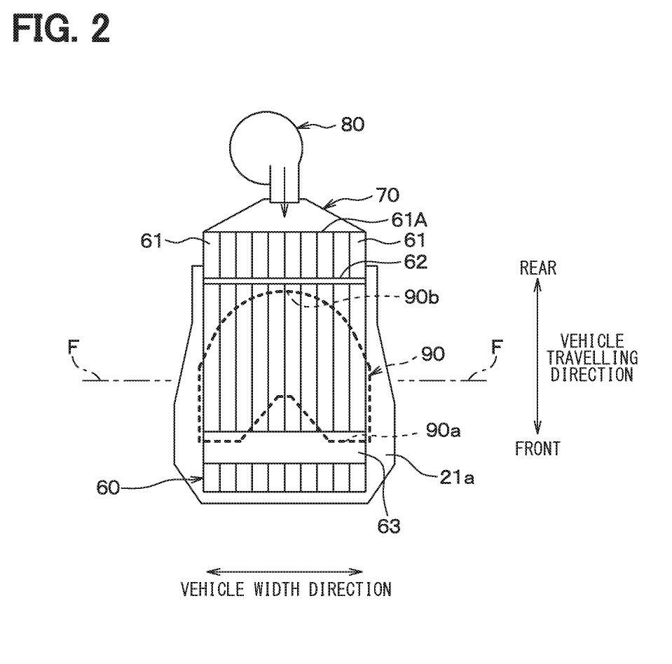

In the above-mentioned first embodiment, an example has been described in which the rear side ventilation port 62 is formed in the U shape, while the front side ventilation port 63 is formed in the V shape. However, alternatively, in a present second embodiment, an example will be described in which each of the rear side ventilation port 62 and the front side ventilation port 63 is formed in a belt shape that extends in the vehicle width direction, referring to FIG. 2.

FIG. 2 shows a ventilation passage member 60 of the sheet 10 of the present embodiment. A vehicle seat air conditioner of the present embodiment and the vehicle seat air conditioner of the above-mentioned first embodiment differ only in the shapes of the rear side ventilation port 62 and the front side ventilation port 63, but are substantially the same in other configurations. Therefore, the shapes of the rear side ventilation port 62 and the front side ventilation port 63 will be described.

The dimension in the vehicle width direction of the rear side ventilation port 62 and the dimension in the vehicle width direction of the front side ventilation port 63 are the same. The dimension in the vehicle traveling direction of the front side ventilation port 63 is larger than the dimension in the vehicle traveling direction of the rear side ventilation port 62. Therefore, the opening area of the front side ventilation port 63 is larger than the opening area of the rear side ventilation port 62.

When the user sits on the seat 10, the region of the plurality of tubes 61 in the ventilation passage member 60 located between the rear side ventilation port 62 and the front side ventilation port 63 is elastically deformed and contracted by the pressure applied from the thighs or buttocks of the user. Consequently, the pressure loss generated when the airflow passes through the plurality of tubes 61 might become larger.

Thus, if the opening area of the rear side ventilation port 62 and the opening area of the front side ventilation port 63 are the same, when the user sits on the seat 10, the pressure loss in the air flow passage becomes larger than when the user does not sit on the seat 10. Consequently, the amount of air blown out of the front side ventilation port 63 is reduced.

In contrast, in the present embodiment, the opening area of the front side ventilation port 63 is set larger than the opening area of the rear side ventilation port 62 as mentioned above. Consequently, the amount of air blown out of the front side ventilation port 63 can be prevented from being reduced when the user sits on the seat 10.

In the present embodiment, the rear side ventilation port 62 and the front side ventilation port 63 are disposed such that the seating portion 90 overlaps with the portion of the ventilation passage member 60 located between the rear side ventilation port 62 and the front side ventilation port 63.

The rear side ventilation port 62 is located on the rear side in the vehicle traveling direction of the ventilation passage member 60 with respect to the center line F. The rear side ventilation port 62 is disposed in a portion, which avoids the seating portion 90, within the ventilation passage member 60.

The front side ventilation port 63 is located on the front side in the vehicle traveling direction of the ventilation passage member 60 with respect to the center line F. The front side ventilation port 63 is disposed to overlap with the seating portion 90 of the ventilation passage member 60.

More specifically, a front side seating end 90a is defined as an end of the seating portion 90 located on the most front side in the vehicle traveling direction, and a rear side seating end 90b is defined as an end of the seating portion 90 located on the most rear side in the vehicle traveling direction.

In the present embodiment, the rear side ventilation port 62 and the front side ventilation port 63 are disposed such that the front side seating end 90a is disposed in the position that overlaps with the front side ventilation port 63, while the rear side seating end 90b is disposed in a position on the front side in the vehicle traveling direction with respect to the rear side ventilation port 62.

In any portion located between the rear side ventilation port 62 and the front side ventilation port 63 in the ventilation passage member 60 of the present embodiment, no ventilation port is provided for blowing the airflow from the air flow passage to the user or for drawing the airflow from the user side into the air flow passage.

According to the present embodiment described above, in the vehicle seat air conditioner, the ventilation passage member 60 is formed so as to close the area between the inside and outside of each of the plurality of air flow passages, over the entire region of the ventilation passage member 60 between the rear side ventilation port 62 and the front side ventilation port 63 in the ventilation passage member 60.

Therefore, like the above-mentioned first embodiment, the two adjacent tubes 61 of the plurality of tubes 61 support each other in the ventilation passage member 60, even when any pressure is applied from the thighs or buttocks of the user to the region between the rear side ventilation port 62 and the front side ventilation port 63 in the ventilation passage member 60.

Thus, the region between the rear side ventilation port 62 and the front side ventilation port 63 in the ventilation passage member 60 can be prevented from being collapsed due to its elastic deformation. Consequently, the airflow can be blown out of each of the rear side ventilation port 62 and the front side ventilation port 63. Therefore, the seat air conditioner can be provided which prevents the user from feeling less comfortable.

### Third Embodiment

In the above-mentioned first embodiment, an example has been described in which the ventilation passage member 60 is disposed on the surface 21a of the seat cushion 20. However, alternatively, in a present third embodiment, an example will be described in which the ventilation passage member 60 is disposed on a surface 31a of the seat back 30.

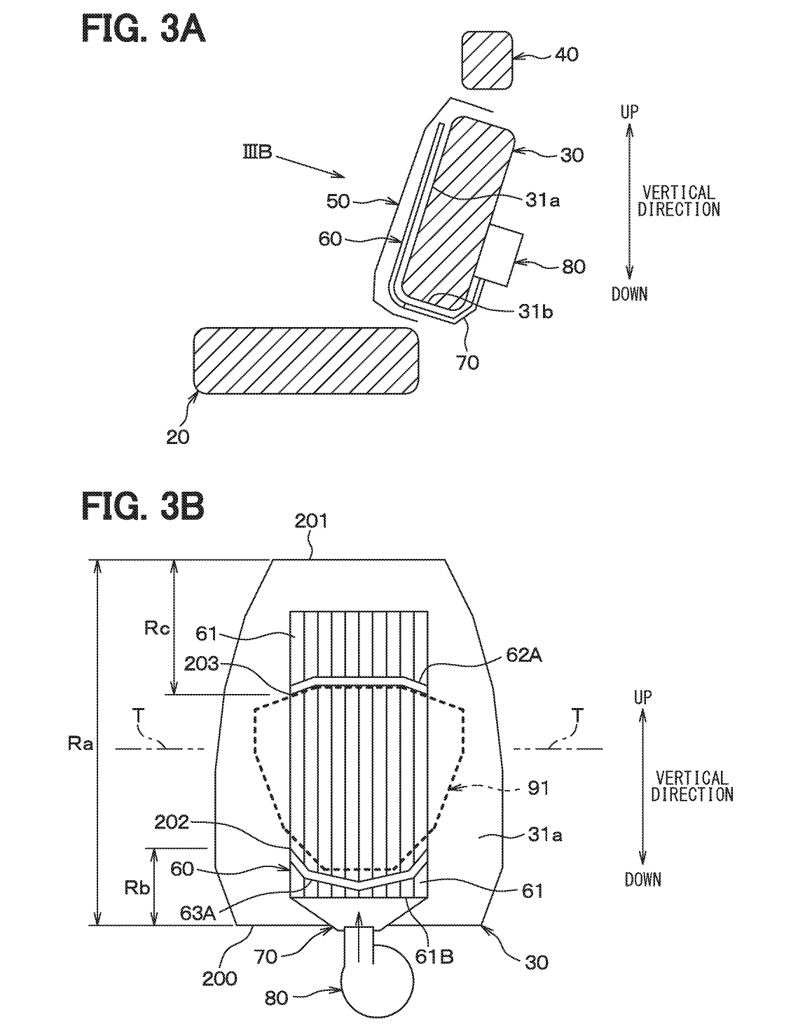

FIGS. 3A and 3B show a configuration of the seat 10 of the present embodiment. The seat 10 of the present embodiment and the seat 10 of the above-mentioned first embodiment differ only in the cover 50, the ventilation passage member 60, the connecting portion 70, and the electric blower 80, but are substantially the same in other configurations. Now, the cover 50, the ventilation passage member 60, the connecting portion 70, and the electric blower 80 will be described.

The cover 50 of the present embodiment is disposed so as to cover the surface 31a of the seat back 30.

The ventilation passage member 60 is disposed between the seat back 30 and the cover 50. The ventilation passage member 60 is provided along the surface 31a and a side wall 31b of the seat back 30.

The ventilation passage member 60 is formed by integrally arranging a plurality of tubes 61 in a sheet shape such that the tubes are adjacent to each other in the vehicle width direction. The plurality of tubes 61 respectively form air flow passages through which the airflows circulate to the upper side in the vertical direction along the surface 31a of the seat back 30.

The direction in which the airflow flows through the ventilation passage member 60 of the present embodiment is a predetermined direction intersecting (for example, orthogonal to) the vehicle width direction.

The ventilation passage member 60 is configured to be elastically deformable by a pressure applied from the back of the user.

The ventilation passage member 60 is provided with an air inlet 61B where the airflow blown from the electric blower 80 enters. The air inlet 61B is formed to be open on the lower side in the vertical direction of the ventilation passage member 60. The air inlet 61B is constituted of respective air inlets of the plurality of tubes 61.

The ventilation passage member 60 is provided with an upper side ventilation port 62A and a lower side ventilation port 63A which are open on the side of the cover 50. The upper side ventilation port 62A is configured by arranging communication holes that communicate between the inside and the outside of each of the plurality of tubes 61. The upper side ventilation port 62A is formed in a curved shape that is convex upward in the vertical direction.

Specifically, the upper side ventilation port 62A is formed in the curved shape that extends downward in the vertical direction, from the center in the vehicle width direction toward one side in the vehicle width direction, and also extends downward in the vertical direction, from the center in the vehicle width direction toward the other side in the vehicle width direction. Consequently, the upper side ventilation port 62A is formed along the portion connecting the left and right shoulders and the neck of the seated occupant.

The lower side ventilation port 63A is configured by arranging communication holes that communicate between the inside and the outside of each of the plurality of tubes 61. The lower side ventilation port 63A is formed in a curved shape that is convex downward in the vertical direction.

Specifically, the lower side ventilation port 63A is formed in the curved shape that extends upward in the vertical direction, from the center in the vehicle width direction toward one side in the vehicle width direction, and also extends upward in the vertical direction, from the center in the vehicle width direction toward the other side in the vehicle width direction. Consequently, the lower side ventilation port 63A is formed along the waist of the seated occupant.

The ventilation passage member 60 functions to circulate an airflow supplied from the electric blower 80 through the connecting portion 70 into the plurality of tubes and to blow out the airflow from each of the upper side ventilation port 62A and the lower side ventilation port 63A into the interior of the vehicle cabin.

A center line T is defined as an imaginary line that extends in the vehicle width direction orthogonal to the vertical direction while passing through the midpoint in the vertical direction of the seat back 30.

In other words, a third distance is defined as a distance between the center line T and a lower end 200 in the vehicle vertical direction of the surface 31a of the seat back 30. A fourth distance is defined as a distance between the center line T and an upper end 201 in the vehicle vertical direction of the surface 31a of the seat back 30. Thus, the central line T is an imaginary line set so that the third distance and the fourth distance are the same.

The lower side ventilation port 63A is located on the lower side in the vertical direction of the seat back 30 with respect to the center line T. The lower side ventilation port 63A is disposed in a portion, which avoids a seating portion 91, within the seat back 30.

The seating portion 91 of the present embodiment is a portion of the seat back 30 that mainly supports the back of the user, i.e., a portion of the seat back 30 that mainly receives the pressure from the back of the user.

The upper side ventilation port 62A is located on the upper side in the vertical direction of the seat back 30 with respect to the center line T. The upper side ventilation port 62A is disposed in a portion, which avoids the seating portion 91, within the seat back 30.

Thus, the lower side ventilation port 63A is disposed on the lower side in the vertical direction with respect to the seating portion 91. The upper side ventilation port 62A is disposed on the upper side in the vertical direction with respect to the seating portion 91. The lower side ventilation port 63A and the upper side ventilation port 62A are disposed so that the seating portion 91 overlaps with a portion between the lower side ventilation port 63A and the upper side ventilation port 62A.

The plurality of tubes of the ventilation passage member 60 are formed such that other portions of the ventilation passage member 60 configured in this way, except for the upper side ventilation port 62A, the lower side ventilation port 63A, and the air inlet 61B, entirely close the area between the inside and outside of each of the plurality of air flow passages.

Specifically, the plurality of tubes of the ventilation passage member 60 are formed so as to close the area between the inside and outside of each of the plurality of air flow passages, over the entire region of the ventilation passage member 60 between the upper side ventilation port 62A and the lower side ventilation port 63A.

The plurality of tubes of the ventilation passage member 60 are formed such that the other portion of the ventilation passage member 60 located on the upper side in the vertical direction with respect to the upper side ventilation port 62A entirely closes the area between the inside and outside of each of the plurality of air flow passages.

The plurality of tubes of the ventilation passage member 60 are formed such that the other portion of the ventilation passage member 60 located on the lower side in the vertical direction with respect to the lower side ventilation port 63A, except for the air inlet 61B, entirely closes the area between the inside and outside of each of the plurality of air flow passages.

An air inlet of the connecting portion 70 is connected to an air outlet of the electric blower 80. An air outlet of the connecting portion 70 is connected to an air inlet 61B of the ventilation passage member 60.

That is, the connecting portion 70 is a duct that is disposed between the electric blower 80 and the plurality of tubes 61 of the ventilation passage member 60 and constitutes an air flow passage for distributing the airflow from the electric blower 80 to the plurality of tubes 61 of the ventilation passage member 60.

The electric blower 80 draws an airflow in the interior of the vehicle cabin and blows the airflow toward the plurality of tubes 61 of the ventilation passage member 60 through the connecting portion 70. The electric blower 80 of the present embodiment is disposed on the back surface of the seat back 30.

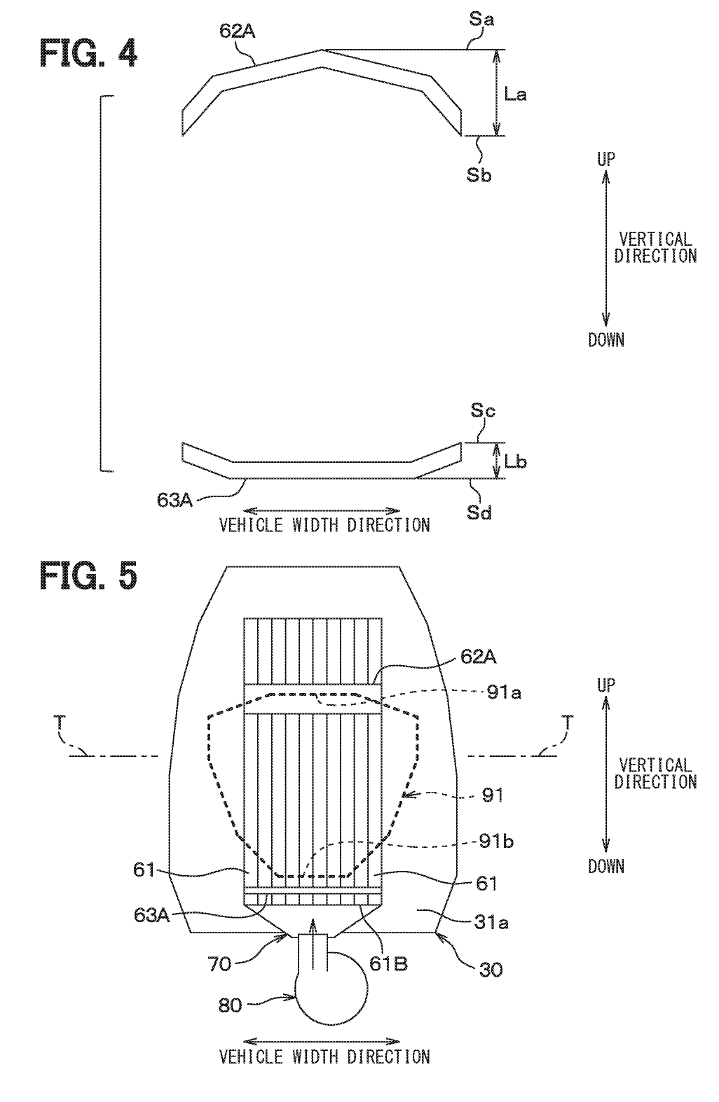

Next, the upper side ventilation port 62A and the lower side ventilation port 63A of the present embodiment will be described below with reference to FIG. 4.

A reference line Sa is defined as an imaginary line that extends in the vehicle width direction while passing through the uppermost side in the vertical direction of the upper side ventilation port 62A. A reference line Sb is defined as an imaginary line that extends in the vehicle width direction while passing through the lowermost side in the vertical direction of the upper side ventilation port 62A. La is defined as a distance between the reference line Sa and the reference line Sb.

A reference line Sc is defined as an imaginary line that extends in the vehicle width direction while passing through the uppermost side in the vertical direction of the lower side ventilation port 63A. A reference line Sd is defined as an imaginary line that extends in the vehicle width direction while passing through the lowermost side in the vertical direction of the lower side ventilation port 63A. Lb is a distance between the reference line Sc and the reference line Sd. The upper side ventilation port 62A and the lower side ventilation port 63A are formed to satisfy the relationship of Lb<La.

The ventilation passage member 60, the connecting portion 70, and the electric blower 80 configured in this way constitute the vehicle seat air conditioner.

Next, the operation of the vehicle seat air conditioner of the present embodiment will be described.

When electric power is supplied to the electric blower 80, the electric blower 80 draws an airflow from the interior of the vehicle cabin and blows out the airflow to the connecting portion 70. Then, the connecting portion 70 divides the airflow blown from the electric blower 80 to supply the divided airflows to the plurality of tubes 61.

In the present embodiment, the ventilation passage member 60 is formed in a sheet shape by integrally arranging a plurality of tubes 61 such that the tubes are adjacent to each other in the vehicle width direction. In addition, the plurality of tubes 61 of the ventilation passage member 60 are formed so as to close the area between the inside and outside of each of the plurality of air flow passages, over the entire region of the ventilation passage member 60 between the upper side ventilation port 62A and the lower side ventilation port 63A.

That is, between the rear side ventilation port 62 and the front side ventilation port 63 in the ventilation passage member 60, no ventilation port is provided for blowing the airflow from the air flow passage of each tube 61 to the occupant or for drawing the airflow from the occupant side into the air flow passage of each tube 61.

Thus, when the user sits on the seat 10, the region of the ventilation passage member 60 between the upper side ventilation port 62A and the lower side ventilation port 63A is elastically deformed by the pressure applied from the back of the user. However, two adjacent tubes 61 of the plurality of tubes 61 support each other. Consequently, each of the plurality of tubes 61 maintains its air flow passage without being collapsed.

Therefore, the airflow supplied from the electric blower 80 to each of the plurality of tubes 61 through the connecting portion 70 passes through the seating portion 91 of the plurality of tubes 61 to flow to the side of the lower side ventilation port 63A. Consequently, the airflow is blown out to the waist, both shoulders, and the like of the occupant through the plurality of fine holes in the cover 50, from each of the upper side ventilation port 62A and the lower side ventilation port 63A of the ventilation passage member 60.

According to the present embodiment described above, the vehicle seat air conditioner is used in the seat 10 that includes the seat back 30 for supporting the back of the user on its surface 31a. The vehicle seat air conditioner includes the ventilation passage member 60 that is disposed on the surface 31a of the seat back 30, is elastically deformed by the pressure applied from the back of the user, and has the plurality of tubes 61 respectively forming the air flow passages for circulating the airflow upward in the vertical direction. The ventilation passage member 60 has the lower side ventilation port 63A and the upper side ventilation port 62A formed therein, each port communicating between the inside and outside of each air flow passage.

The lower side ventilation port 63A is disposed in a portion, which avoids the seating portion 91, within the seat back 30. The lower side ventilation port 63A is located on the lower side in the vertical direction of the ventilation passage member 60 with respect to the center line T. The upper side ventilation port 62A is disposed in a portion, which avoids the seating portion 91, within the seat back 30. The upper side ventilation port 62A is located on the upper side in the vertical direction of the ventilation passage member 60 with respect to the center line T. The lower side ventilation port 63A and the upper side ventilation port 62A are disposed so that the seating portion 91 overlaps with the portion of the ventilation passage member 60 between the lower side ventilation port 63A and the upper side ventilation port 62A.

The ventilation passage member 60 is formed so as to close the area between the inside and outside of each of the plurality of air flow passages, over the entire region of the ventilation passage member 60 between the lower side ventilation port 63A and the upper side ventilation port 62A.

Therefore, the region of the ventilation passage member 60 between the lower side ventilation port 63A and the upper side ventilation port 62A is prevented from being collapsed due to its elastic deformation even when any pressure is applied from the back of the user to the region of the ventilation passage member 60 between the lower side ventilation port 63A and the upper side ventilation port 62A. Consequently, the airflow can be blown out of each of the lower side ventilation port 63A and the upper side ventilation port 62A. Thus, the seat air conditioner can be provided which prevents the user from feeling less comfortable.

The upper side ventilation port 62A of the present embodiment is formed in a curved shape that is convex upward in the vertical direction. The lower side ventilation port 63A is formed in a curved shape that is convex downward in the vertical direction. The upper side ventilation port 62A and the lower side ventilation port 63A are formed so as to satisfy the relationship of Lb<La.

Consequently, the upper side ventilation port 62A is formed along the portion connecting the left and right shoulders and neck of the seated occupant. The lower side ventilation port 63A is formed along the waist and buttocks of the seated occupant. Thus, the airflow from the upper side ventilation port 62A can be blown to the left and right shoulders and neck of the seated occupant. In addition, the airflow from the lower side ventilation port 63A can also be blown to the waist and buttocks of the seated occupant. Therefore, the user can feel more comfortable.

The plurality of tubes 61 of the ventilation passage member 60 in the present embodiment are formed such that other portions of the ventilation passage member 60, except for the upper side ventilation port 62A, the lower side ventilation port 63A, and the air inlet 61B, entirely close the area between the inside and outside of each of the plurality of air flow passages.

Thus, the amount of air blown out of the upper side ventilation port 62A and the lower side ventilation port 63A can be ensured.

Next, referring to FIG. 3B, a description will be given on the positional relationship between the lower side ventilation port 63A and the upper side ventilation port 62A with respect to the surface 21a of the seat back 30 in the present embodiment.

A dimension Ra is defined as a distance between the lower end 200 in the vehicle vertical direction and the upper end 201 in the vehicle vertical direction at the surface 31a of the seat back 30.

A dimension Rb is defined as a distance between the lower end 200 in the vehicle vertical direction of the surface 31a of the seat back 30 and an upper end 202 in the vehicle vertical direction of the lower side ventilation port 63A.

The lower side ventilation port 63A is formed such that We is 40% or less, where We (=Rb/Ra) is a ratio of the dimension Rb to the dimension Ra in percentage on the assumption that the dimension Ra is 100%.

A dimension Rc is defined as a distance between the upper end 201 in the vehicle vertical direction of the surface 31a of the seat back 30 and a lower end 203 in the vehicle traveling direction of the upper side ventilation port 62A.

The upper side ventilation port 62A is formed such that Wf is 30% or less, where Wf (=Rc/Ra) is a ratio of the dimension Rc to the dimension Ra in percentage on the assumption that the dimension Ra is 100%.

Alternatively, the lower side ventilation port 63A is formed such that We is 30% or less, whereas the upper side ventilation port 62A is formed such that Wf is 20% or less.

The upper side ventilation port 62A and the lower side ventilation port 63A are formed so as to achieve such We and Wf. Consequently, the upper side ventilation port 62A is disposed on the rear side in the vehicle traveling direction with respect to a portion of the seat back 30 which the occupant is in contact with. Thus, the lower side ventilation port 63A is disposed on the front side in the vehicle traveling direction with respect to the portion of the seat back 30 which the occupant is in contact with.

With the above-mentioned configuration, the waist portion or the like of the occupant is placed between the upper side ventilation port 62A and the lower side ventilation port 63A of the seat back 30, thereby preventing the upper side ventilation port 62A and the lower side ventilation port 63A from being closed by a part of the body of the occupant.

### Fourth Embodiment

In the above-mentioned third embodiment, an example has been described in which each of the upper side ventilation port 62A and the lower side ventilation port 63A is formed in a curved shape. However, alternatively, in a present fourth embodiment, an example will be described in which each of the upper side ventilation port 62A and the lower side ventilation port 63A is formed in a belt shape that extends in the vehicle width direction.

FIG. 5 shows a ventilation passage member 60 of the sheet 10 in the present embodiment. A vehicle seat air conditioner of the present embodiment and the vehicle seat air conditioner of the above-mentioned third embodiment differ only in the shapes of the upper side ventilation port 62A and the lower side ventilation port 63A, but are substantially the same in other configurations. Thus, the shapes of the upper side ventilation port 62A and the lower side ventilation port 63A will be described.

The dimension in the vehicle width direction of the upper side ventilation port 62A and the dimension in the vehicle width direction of the lower side ventilation port 63A are the same. The dimension in the vehicle traveling direction of the upper side ventilation port 62A is larger than the dimension in the vehicle traveling direction of the lower side ventilation port 63A. Therefore, the opening area of the upper side ventilation port 62A is larger than the opening area of the lower side ventilation port 63A.

When the user sits on the seat 10, the region of the plurality of tubes 61 in the ventilation passage member 60, which is located between the upper side ventilation port 62A and the lower side ventilation port 63A, is elastically deformed and contracted by the pressure applied from the back of the user. Consequently, the pressure loss generated when the airflow passes through the plurality of tubes 61 becomes larger.

Thus, if the opening area of the upper side ventilation port 62A and the opening area of the lower side ventilation port 63A are the same, when the user sits on the seat 10, the pressure loss in the air flow passage becomes larger than when the user does not sit on the seat 10. Consequently, the amount of air blown out of the lower side ventilation port 63A is reduced.

In contrast, in the present embodiment, the opening area of the lower side ventilation port 63A is set larger than the opening area of the upper side ventilation port 62A as mentioned above. Consequently, the amount of air blown out of the lower side ventilation port 63A can be prevented from being reduced when the user sits on the seat 10.

In the present embodiment, the upper side ventilation port 62A and the lower side ventilation port 63A are disposed such that the seating portion 91 overlaps with the portion of the ventilation passage member 60 located between the upper side ventilation port 62A and the lower side ventilation port 63A.

The upper side ventilation port 62A is located on the upper side in the vehicle vertical direction of the ventilation passage member 60 with respect to the center line T. The upper side ventilation port 62A is disposed in a portion of the ventilation passage member 60 that overlaps with the seating portion 91.

The lower side ventilation port 63A is located on the lower side in the vehicle vertical direction of the ventilation passage member 60 with respect to the center line T. The lower side ventilation port 63A is disposed in a portion, which avoids the seating portion 91, within the ventilation passage member 60.

More specifically, an upper side seating end 91a is defined as an end of the seating portion 91 located on the uppermost side in the vertical direction, and a lower side seating end 91b is defined as an end of the seating portion 91 located on the lowermost side in the vertical direction.

In the present embodiment, the upper side ventilation port 62A and the lower side ventilation port 63A are disposed such that the upper side seating end 91a is disposed in a position that overlaps with the upper side ventilation port 62A, while the lower side seating end 91b is disposed in a position on the upper side in the vertical direction with respect to the lower side ventilation port 63A.

In any portion located between the upper side ventilation port 62A and the lower side ventilation port 63A in the ventilation passage member 60 of the present embodiment, no ventilation port is provided for blowing the airflow from the air flow passage to the user or for drawing the airflow from the user side into the air flow passage.

According to the present embodiment described above, the region of the ventilation passage member 60 between the lower side ventilation port 63A and the upper side ventilation port 62A is prevented from being collapsed due to its elastic deformation even when any pressure is applied from the back of the user to the region of the ventilation passage member 60 between the lower side ventilation port 63A and the upper side ventilation port 62A. Consequently, the airflow can be blown out of each of the lower side ventilation port 63A and the upper side ventilation port 62A. Thus, the seat air conditioner can be provided which prevents the user from feeling less comfortable.

### Fifth Embodiment

In the above-mentioned first embodiment, an example has been described in which the ventilation passage member 60 is provided along the side wall 21b of the seat cushion 20, thereby connecting the ventilation passage member 60 and the electric blower 80.

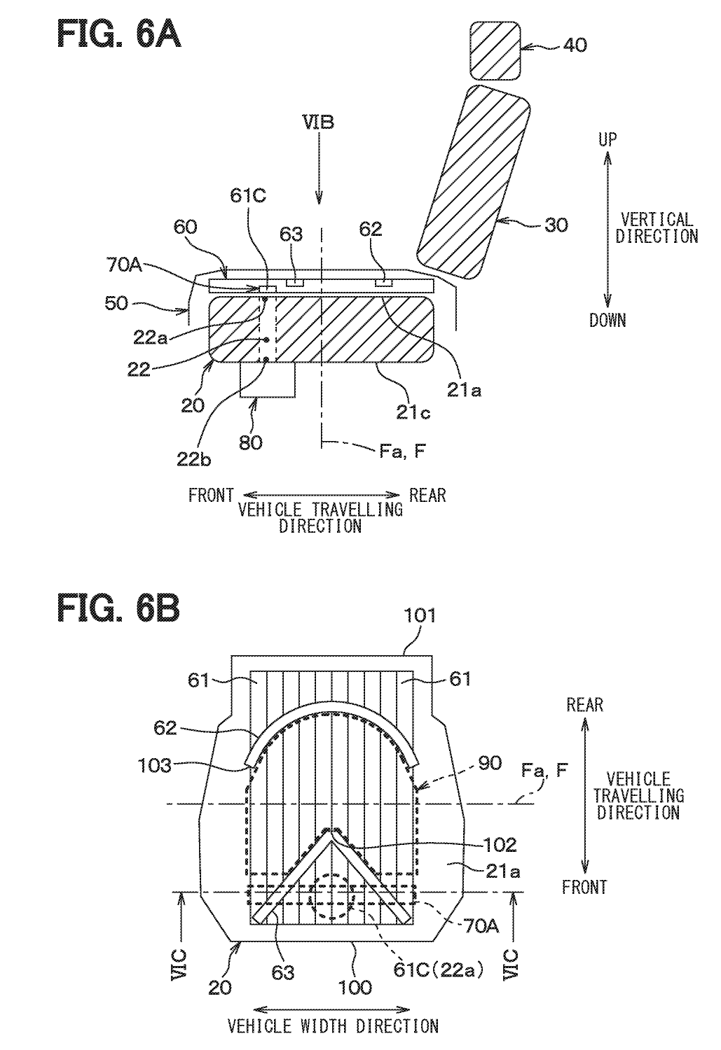

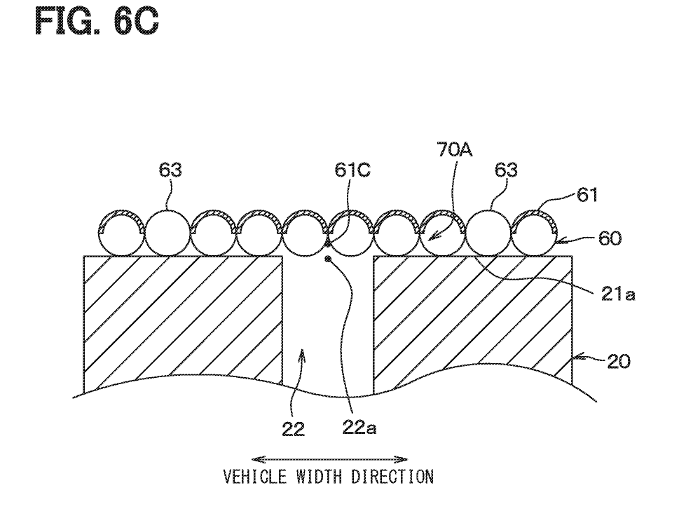

Alternatively, in a present fifth embodiment, a description will be given on a seat air conditioner that employs a through hole 22 in the seat cushion 20 to connect the ventilation passage member 60 and the electric blower 80 through the through hole 22 with reference to FIGS. 6A, 6B, and 6C.

The present embodiment and the above-mentioned first embodiment differ only in the structure connecting between the ventilation passage member 60 and the electric blower 80, but are substantially the same in other configurations, and thus a description thereof will be simplified below. In FIGS. 6A and 6B, the same reference characters as those in FIGS. 1A and 1B denote the same components.

The through hole 22 penetrates between a back surface 21c and the surface 21a of the seat cushion 20. The through hole 22 of the present embodiment constitutes an air flow passage for circulating an airflow between the ventilation passage member 60 and the electric blower 80.

A surface opening portion 22a with the through hole 22 opened thereat is provided on the surface 21a of the seat cushion 20. The surface opening portion 22a is located on the front side in the vehicle traveling direction of the surface 21a of the seat cushion 20 with respect to the seating center line Fa.

The seating center line Fa as used herein is an imaginary line that extends in the vehicle width direction (i.e., the direction intersecting the vehicle traveling direction) while passing through the midpoint in the vehicle traveling direction of the seating portion 90 on the surface 21a of the seat cushion 20. In the present embodiment, the seating center line Fa is the same imaginary line as the center line F. A back surface opening portion 22b with the through hole 22 opened thereat is provided on the back surface 21c of the seat cushion 20.

The ventilation passage member 60 of the present embodiment is provided with an air inlet/outlet 61C. The air inlet/outlet 61C is provided on the side of the surface 21a of the seat cushion 20 in the ventilation passage member 60. Specifically, the air inlet/outlet 61C is formed to be opened on the side of the surface 21a of the seat cushion 20 at the two tubes 61 on the center side in the vehicle width direction of the plurality of tubes 61. The air inlet/outlet 61C is disposed so as to overlap with the surface opening portion 22a of the through hole 22.

In the present embodiment, the air inlet/outlet 61C is located on the front side in the vehicle traveling direction of the ventilation passage member 60 with respect to the seating center line Fa. In other words, the air inlet/outlet 61C is located on the front side in the vehicle traveling direction of the front side ventilation port 63 with respect to the rear side 102 in the vehicle traveling direction.

As shown in FIG. 6C, the ventilation passage member 60 is provided with a connection passage 70A that communicates with the air inlet/outlet 61C, instead of the connecting portion 70 shown in FIG. 1. The connection passage 70A causes the air inlet/outlet 61C to communicate with the plurality of tubes 61. Specifically, the connection passage 70A causes the two adjacent tubes 61 of the plurality of tubes 61 to communicate with each other.

The seating portion 90 overlaps with a portion of the ventilation passage member 60 of the present embodiment located between the rear side ventilation port 62 and the front side ventilation port 63. The rear side ventilation port 62 and the front side ventilation port 63 are disposed in portions, which avoid the seating portion 90, within the ventilation passage member 60. In any portion of the ventilation passage member 60 located between the rear side ventilation port 62 and the front side ventilation port 63, no ventilation port is provided for blowing the airflow from the air flow passage to the user or for drawing the airflow from the user side to the air flow passage.

Next, the operation of the vehicle seat air conditioner of the present embodiment will be described.

When electric power is supplied to the electric blower 80, the electric blower 80 draws an airflow from the interior of the vehicle cabin and blows out the airflow to the through hole 22. Then, the airflow blown out of the electric blower 80 passes through the through hole 22 and the air inlet/outlet 61C and then flows into the connection passage 70A. The connection passage 70A divides the airflow and supplies the divided airflows to the plurality of tubes 61.

Here, in the ventilation passage member 60 of the present embodiment, the plurality of tubes 61 of the ventilation passage member 60 are formed so as to close the area between the inside and outside of each of the plurality of air flow passages, over the entire region of the ventilation passage member 60 between the rear side ventilation port 62 and the front side ventilation port 63.

That is, between the rear side ventilation port 62 and the front side ventilation port 63 in the ventilation passage member 60, no ventilation port is provided for blowing the airflow from the air flow passage of each tube 61 to the occupant or for drawing the airflow from the occupant side into the air flow passage of each tube 61.

Thus, when the user sits on the seat 10, the region of the ventilation passage member 60 between the rear side ventilation port 62 and the front side ventilation port 63 is elastically deformed by the pressure applied from the buttocks of the user, like the above-mentioned first embodiment. However, two adjacent tubes 61 of the plurality of tubes 61 support each other. Consequently, each of the plurality of tubes 61 maintains its air flow passage for each tube 61 without being collapsed.

Therefore, the airflow supplied from the electric blower 80 to each of the plurality of tubes 61 through the connecting portion 70 passes through the seating portion 90 of the plurality of tubes 61 to flow to the side of the front side ventilation port 63. Consequently, the airflow is blown out to the buttocks, thighs, and the like of the occupant through the plurality of fine holes in the cover 50, from each of the rear side ventilation port 62 and the front side ventilation port 63 of the ventilation passage member 60.

According to the present embodiment described above, in the vehicle seat air conditioner, the rear side ventilation port 62 and the front side ventilation port 63 are disposed in portions, which avoid the seating portion 91, within the ventilation passage member 60. The seating portion 91 is disposed to overlap with the portion of the ventilation passage member 60 located between the rear side ventilation port 62 and the front side ventilation port 63. The ventilation passage member 60 is formed so as to close the area between the inside and outside of each of the plurality of air flow passages, over the entire region of the ventilation passage member 60 between the rear side ventilation port 62 and the front side ventilation port 63.

Therefore, the region of the ventilation passage member 60 between the rear side ventilation port 62 and the front side ventilation port 63 is prevented from being collapsed due to its elastic deformation even when any pressure is applied from the buttocks of the user to the region of the ventilation passage member 60 between the rear side ventilation port 62 and the front side ventilation port 63. Consequently, the airflow can be blown out of each of the rear side ventilation port 62 and the front side ventilation port 63. Thus, the seat air conditioner can be provided which prevents the user from feeling less comfortable.

In the present embodiment, the ventilation passage member 60 and the electric blower 80 are connected together through the through hole 22 of the seat cushion 20. Thus, the present embodiment does not need disposing the ventilation passage member 60 along the side wall 21b of the seat cushion 20 or providing the connecting portion 70, thereby reducing the size of the body of the seat air conditioner as well as the cost of the seat air conditioner.

### Sixth Embodiment

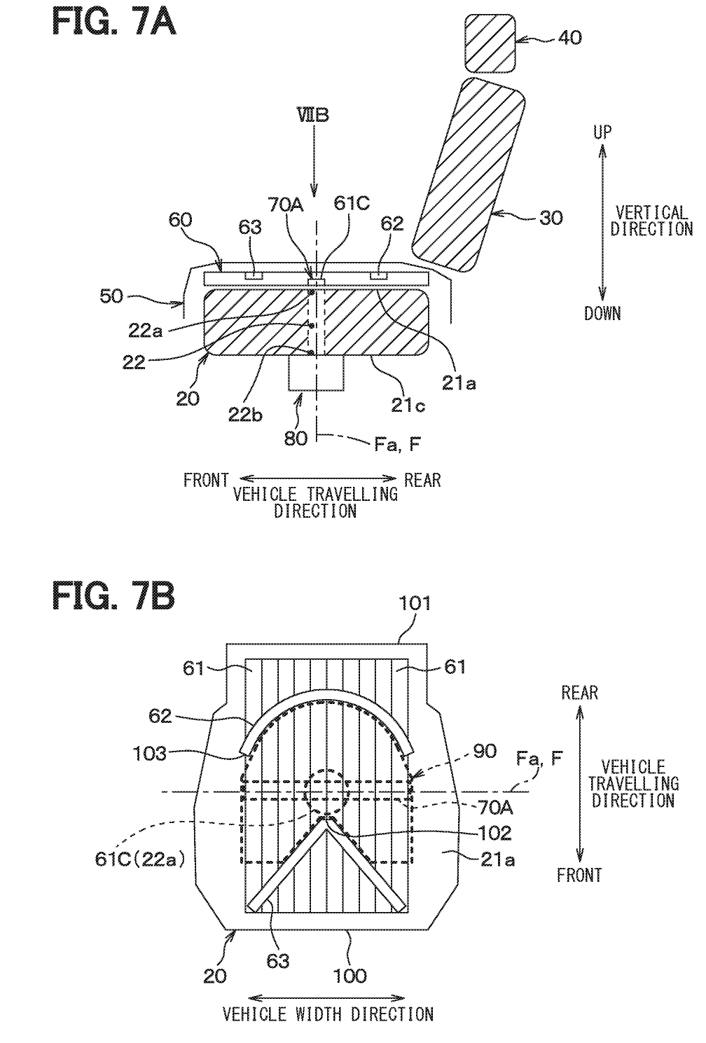

In the above-mentioned fifth embodiment, an example has been described in which the air inlet/outlet 61C of the ventilation passage member 60 is disposed on the front side in the vehicle traveling direction with respect to the front side ventilation port 63. However, alternatively, in a present sixth embodiment, a description will be given on a seat air conditioner in which the air inlet/outlet 61C of the ventilation passage member 60 is disposed to overlap with the seating portion 90, with reference to FIGS. 7A and 7B.

The present embodiment and the above-mentioned fifth embodiment mainly differ only in the air inlet/outlet 61C of the ventilation passage member 60, but are substantially the same in other configurations. In FIGS. 7A and 7B, the same reference characters as those in FIGS. 6A and 6B denote the same components, and thus a description thereof will be omitted.

In the present embodiment, the air inlet/outlet 61C of the ventilation passage member 60 is disposed in a portion that overlaps with the center of the seating portion 90. In other words, the air inlet/outlet 61C of the ventilation passage member 60 is disposed between the front side ventilation port 63 and the rear side ventilation port 62. More in detail, the air inlet/outlet 61C of the ventilation passage member 60 overlaps with the center line F.

The surface opening portion 22a of the through hole 22 is disposed at the center of the seating portion 90 at the surface 21a of the seat cushion 20. That is, the surface opening portion 22a is disposed at a portion of the surface 21a of the seat cushion 20 that overlaps with the seating center line Fa.

In the present embodiment, the rear side ventilation port 62 and the front side ventilation port 63 are disposed in portions, which avoid the seating portion 90, within the ventilation passage member 60.

The ventilation passage member 60 is formed so as to close the area between the inside and outside of each air flow passage, over the entire region of the ventilation passage member 60, except for the air inlet/outlet 61C, between the rear side ventilation port 62 and the front side ventilation port 63.

With the above-mentioned configuration, the region of the ventilation passage member 60 between the rear side ventilation port 62 and the front side ventilation port 63 is prevented from being collapsed due to its elastic deformation even when any pressure is applied from the buttocks of the user to the portion of the ventilation passage member 60 between the rear side ventilation port 62 and the front side ventilation port 63. Consequently, the airflow can be blown out of each of the rear side ventilation port 62 and the front side ventilation port 63. Thus, the seat air conditioner can be provided which prevents the user from feeling less comfortable.

### Seventh Embodiment

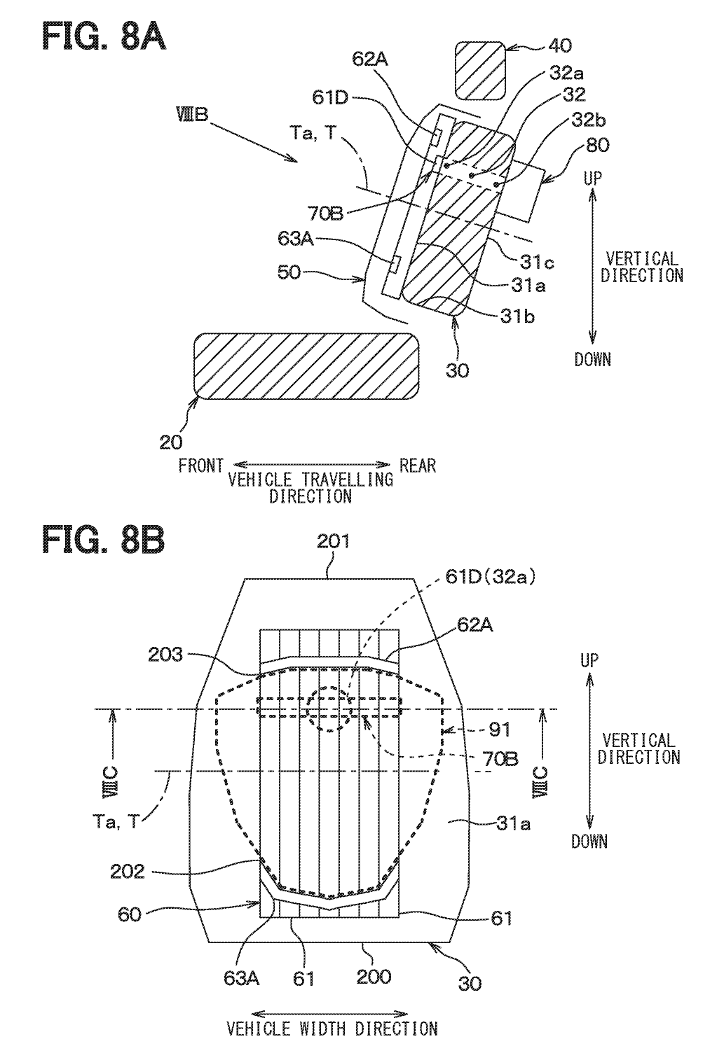

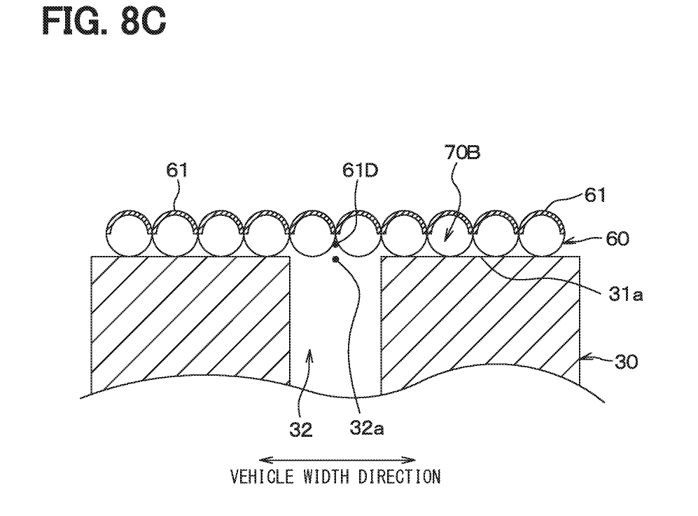

In the above-mentioned third embodiment, an example has been described in which the ventilation passage member 60 is provided along the surface 31a and the side wall 31b of the seat back 30. Alternatively, in a present seventh embodiment, a seat air conditioner will be described in which the ventilation passage member 60 and the electric blower 80 are connected together through a through hole 32 of the seat back 30 with reference to FIGS. 8A, 8B, and 8C.

The present embodiment and the above-mentioned third embodiment differ only in the structure connecting between the ventilation passage member 60 and the electric blower 80, but other configurations are common to both these embodiments, and thus a description thereof will be simplified below. In FIGS. 8A, 8B, and 8C, the same reference characters as those in FIGS. 2, 3A, and 3B denote the same components.

The through hole 32 penetrates between a back surface 31c and the surface 31a of the seat back 30. The through hole of the present embodiment constitutes an air flow passage for circulating an airflow between the ventilation passage member 60 and the electric blower 80.

A surface opening portion 32a with the through hole 32 opened thereat is provided on the surface 31a of the seat back 30. The surface opening portion 32a is disposed on an upper side in the vertical direction (i.e., on the vertically upper side) of the seating portion 91 at the surface 31a of the seat back 30 with respect to the seating center line Ta.

The seating center line Ta as used herein is an imaginary line that extends in the vehicle width direction (i.e., the direction orthogonal to the vertical direction) while passing through the midpoint in the vertical direction of the seating portion 91 on the surface 31a of the seat back 30. The seating center line Ta is the same imaginary line as the center line T in the present embodiment. A back surface opening portion 32b with the through hole 32 opened thereat is provided on the back surface 31c of the seat back 30.

The ventilation passage member 60 of the present embodiment is provided with an air inlet/outlet 61D. The air inlet/outlet 61D is provided on the side of the surface 31a of the seat back 30 in the ventilation passage member 60. Specifically, the air inlet/outlet 61D is formed to be opened on the side of the surface 31a of the seat back 30 at the two tubes 61 on the center side in the vehicle width direction of the plurality of tubes 61. The air inlet/outlet 61D is disposed so as to overlap with the surface opening portion 32a of the through hole 32.

In the present embodiment, the air inlet/outlet 61D is disposed on the upper side in the vertical direction of the ventilation passage member 60 with respect to the center line T and on the lower side in the vertical direction with respect to the rear side ventilation port 62. In other words, the air inlet/outlet 61C is located in an upper side region of the seating portion 91.

As shown in FIG. 8C, the ventilation passage member 60 is provided with a connection passage 70B that communicates with the air inlet/outlet 61D. The connection passage 70B causes the air inlet/outlet 61D to communicate with the plurality of tubes 61. Specifically, the connection passage 70B causes the two adjacent tubes 61 of the plurality of tubes 61 to communicate with each other.

The upper side ventilation port 62A and the lower side ventilation port 63A of the present embodiment are disposed in portions, which avoid the seating portion 90, within the ventilation passage member 60, like the above-mentioned sixth embodiment. The seating portion 90 is disposed to overlap with the portion of the ventilation passage member 60 located between the upper side ventilation port 62A and the lower side ventilation port 63A.

That is, between the upper side ventilation port 62A and the lower side ventilation port 63A in the ventilation passage member 60, no ventilation port is provided for blowing the airflow from the air flow passage to the user or for drawing the airflow from the user side into the air flow passage.

Next, the operation of the vehicle seat air conditioner of the present embodiment will be described.

When electric power is supplied to the electric blower 80, the electric blower 80 draws an airflow from the interior of the vehicle cabin and blows out the airflow to the through hole 32. Then, the airflow blown out of the electric blower 80 passes through the through hole 32 and the air inlet/outlet 61D and then flows to the connection passage 70B. The connection passage 70B divides the airflow and supplies the divided airflows to the plurality of tubes 61.

In the ventilation passage member 60 of the present embodiment, the plurality of tubes 61 of the ventilation passage member 60 are formed so as to close the area between the inside and outside of each of the plurality of air flow passages, over the entire region of the ventilation passage member 60, except for the air inlet/outlet 61C, between the upper side ventilation port 62A and the lower side ventilation port 63A.

That is, between the upper side ventilation port 62A and the lower side ventilation port 63A of the ventilation passage member 60, no ventilation port is provided for blowing the airflow from the air flow passage of each tube 61 to the occupant or for drawing the airflow from the occupant side into the air flow passage of each tube 61.

Thus, when the user sits on the seat 10, the region of the ventilation passage member 60 between the upper side ventilation port 62A and the lower side ventilation port 63A is elastically deformed by the pressure applied from the thighs of the user. However, two adjacent tubes 61 of the plurality of tubes 61 support each other. Consequently, each of the plurality of tubes 61 maintains its air flow passage for each tube 61 without being collapsed.

Therefore, the airflow supplied from the electric blower 80 to each of the plurality of tubes 61 through the connecting portion 70B passes through the seating portion 90 of the plurality of tubes 61 to flow to the side of the lower side ventilation port 63A. Thus, the airflow is blown out to the buttocks, thighs, and the like of the occupant through the plurality of fine holes in the cover 50, from each of the upper side ventilation port 62A and the lower side ventilation port 63A of the ventilation passage member 60.

According to the present embodiment described above, the area between the inside and outside of each air flow passage is closed, over the entire region of the ventilation passage member 60, except for the air inlet/outlet 61D, between the upper side ventilation port 62A and the lower side ventilation port 63A, substantially in the same way as the above-mentioned second embodiment.

Therefore, the region of the ventilation passage member 60 between the upper side ventilation port 62A and the lower side ventilation port 63A is prevented from being collapsed due to its elastic deformation even when any pressure is applied from the buttocks of the user to the region of the ventilation passage member 60 between the upper side ventilation port 62A and the lower side ventilation port 63A. Consequently, the airflow can be blown out of each of the upper side ventilation port 62A and the lower side ventilation port 63A. Thus, the seat air conditioner can be provided which prevents the user from feeling less comfortable.

In the present embodiment, the ventilation passage member 60 and the electric blower 80 communicate with each other through the through hole 32 of the seat back 30. Thus, the present embodiment does not need disposing the ventilation passage member 60 along the side wall 31b of the seat back 30 or providing the connecting portion 70, thereby making it possible to reduce the size of the body of the seat air conditioner as well as the cost of the seat air conditioner.

### Eighth Embodiment

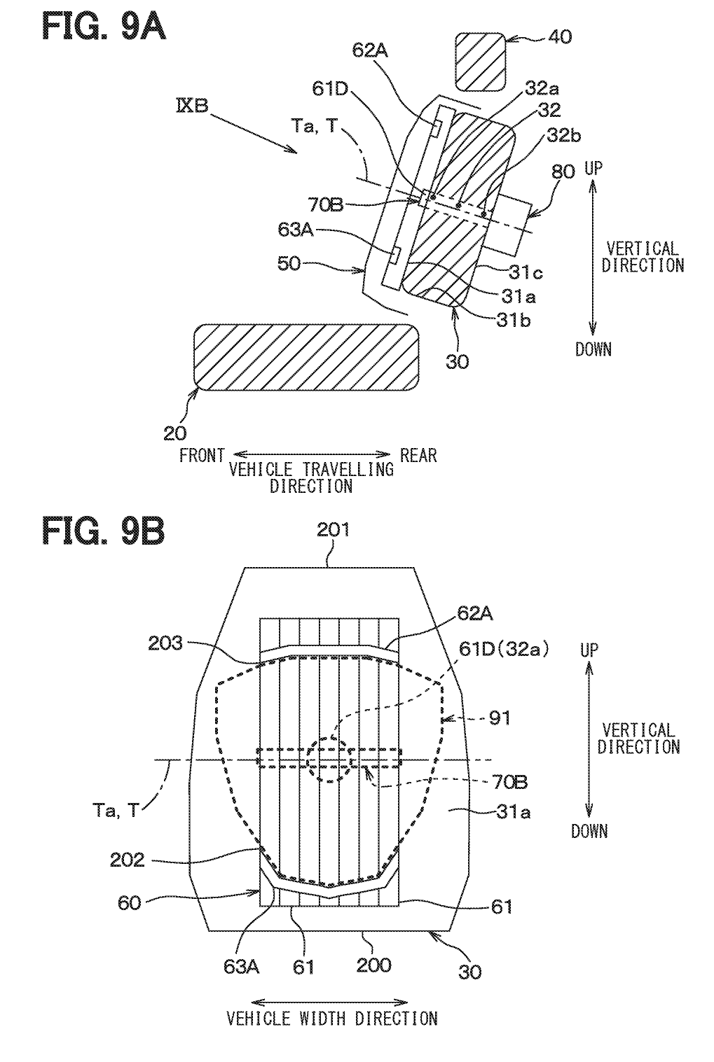

In the above-mentioned seventh embodiment, an example has been described in which the air inlet/outlet 61D of the ventilation passage member 60 is disposed on the upper side in the vertical direction of the seat back 30 with respect to the center line F. However, alternatively, in a present eighth embodiment, a seat air conditioner will be described in which the air inlet/outlet 61D of the ventilation passage member 60 is disposed at the center of the seat back 30, with reference to FIGS. 9A and 9B.

The present embodiment and the above-mentioned seventh embodiment mainly differ only in the position of the air inlet/outlet 61D of the ventilation passage member 60, but are substantially the same in other configurations. In FIGS. 9A and 9B, the same reference characters as those in FIGS. 8A and 8B denote the same components, and thus a description thereof will be omitted.

In the present embodiment, the air inlet/outlet 61D of the ventilation passage member 60 is disposed in the portion that overlaps with the center of the seating portion 90 in the ventilation passage member 60. In other words, the air inlet/outlet 61D of the ventilation passage member 60 is disposed between the lower side ventilation port 63A and the upper side ventilation port 62. More in detail, the air inlet/outlet 61D of the ventilation passage member 60 overlaps with the center of the seat back 30.

The surface opening portion 32a of the through hole 32 is disposed at the center of the seating portion 91 on the surface 31a of the seat back 30. That is, the surface opening portion 32a of the through hole 32 is disposed at a portion of the surface 31a of the seat back 30 that overlaps with the seating center line Ta.

In the present embodiment, the ventilation passage member 60 is formed so as to close the area between the inside and outside of each of the plurality of air flow passages, over the entire region of the ventilation passage member 60, except for the air inlet/outlet 61D, between the lower side ventilation port 63A and the upper side ventilation port 63B.

In other words, between the lower side ventilation port 63A and the upper side ventilation port 62A in the ventilation passage member 60, no ventilation port is provided for blowing the airflow from the air flow passage to the user or for drawing the airflow from the user side into the air flow passage.

The lower side ventilation port 63A and the upper side ventilation port 62A of the present embodiment are disposed in portions, which avoid the seating portion 91, within the ventilation passage member 60, like the above-mentioned seventh embodiment.

With the above-mentioned configuration, a region of the ventilation passage member 60 between the rear side ventilation port 62 and the front side ventilation port 63 is prevented from being collapsed due to its elastic deformation even when any pressure is applied from the back of the user to the region of the ventilation passage member 60 between the rear side ventilation port 62 and the front side ventilation port 63. Consequently, the airflow can be blown out of each of the lower side ventilation port 63A and the upper side ventilation port 62A. Thus, the seat air conditioner can be provided which prevents the user from feeling less comfortable.

### Ninth Embodiment

In the above-mentioned second embodiment, an example has been described in which the ventilation passage member 60 is provided along the side wall 21b of the seat cushion 20, thereby connecting the ventilation passage member 60 and the electric blower 80.

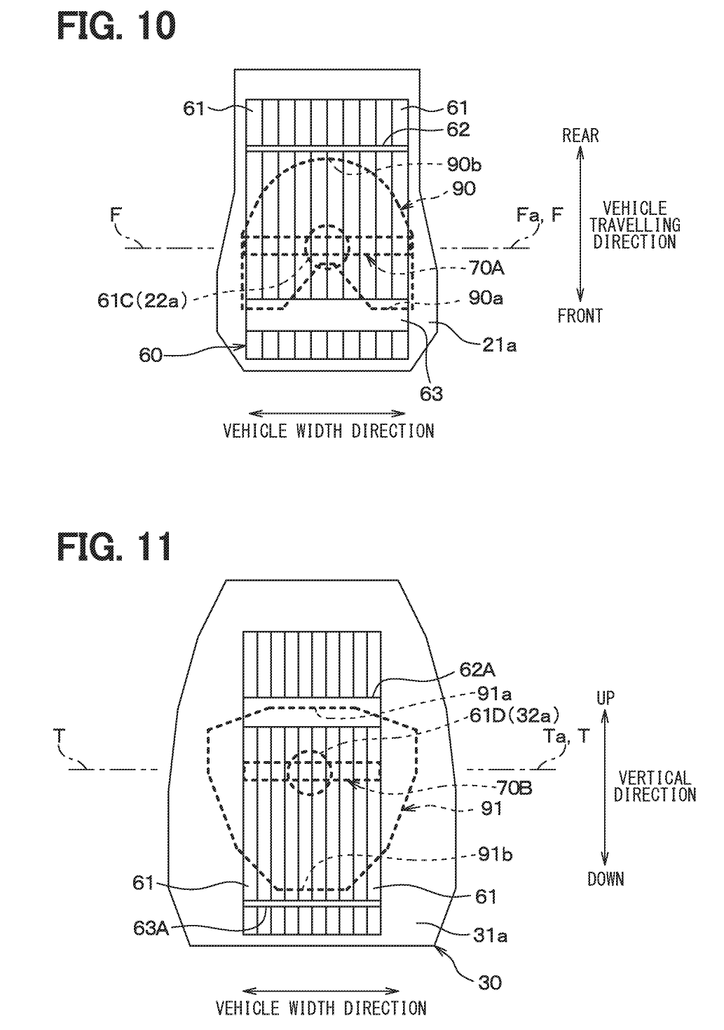

Alternatively, in a present ninth embodiment, a seat air conditioner will be described in which the ventilation passage member 60 and the electric blower 80 are connected together through the through hole of the seat cushion 20, with reference to FIG. 10.

The present embodiment and the above-mentioned second embodiment differ only in the structure connecting between the ventilation passage member 60 and the electric blower 80, but other configurations are common to both these embodiments, and thus a description thereof will be simplified below. In FIG. 10, the same reference characters as those in FIG. 2 denote the same components.

A through hole of the seat cushion 20 in the present embodiment penetrates between a back surface and the surface of the seat cushion 20, like the above-mentioned sixth embodiment. The through hole constitutes an air flow passage for circulating an airflow between the ventilation passage member 60 and the electric blower 80.

The surface opening portion 22a with the through hole opened thereat is provided on the surface 21a of the seat cushion 20. The surface opening portion 22a is disposed at the center of the seating portion 90. That is, the surface opening portion 22a is disposed at a portion of the surface 21a of the seat cushion 20 that overlaps with the seating center line Fa.

The ventilation passage member 60 of the present embodiment is provided with the air inlet/outlet 61C. The air inlet/outlet 61C is provided on the side of the surface 21a of the seat cushion 20 in the ventilation passage member 60.

Specifically, the air inlet/outlet 61C is formed to be opened on the side of the surface 21a of the seat cushion 20 at the two tubes 61 on the center side in the vehicle width direction of the plurality of tubes 61. The air inlet/outlet 61C is disposed so as to overlap with the surface opening portion 22a of the through hole.

Instead of the connecting portion 70 shown in FIG. 1, the ventilation passage member 60 is provided with the connection passage 70A that communicates with the air inlet/outlet 61C. The connection passage 70A causes the air inlet/outlet 61C to communicate with the plurality of tubes 61. Specifically, the connection passage 70A causes the two adjacent tubes 61 of the plurality of tubes 61 to communicate with each other.

The operation of the seat air conditioner of the present embodiment is substantially the same as that of the seat air conditioner of the above-mentioned sixth embodiment, and thus a description thereof will be omitted.

### Tenth Embodiment

In the above-mentioned fourth embodiment, an example has been described in which the ventilation passage member 60 is provided along the surface 31a and the side wall 31b of the seat back 30. Alternatively, in a present tenth embodiment, a seat air conditioner will be described in which the ventilation passage member 60 and the electric blower 80 are connected together through the through hole 32 of the seat back 30, with reference to FIG. 11.

The present embodiment and the above-mentioned fourth embodiment differ only in the structure connecting between the ventilation passage member 60 and the electric blower 80, but other configurations are common to both these embodiments, and thus a description thereof will be simplified below. In FIG. 11, the same reference characters as those in FIG. 5 denote the same components.

The through hole of the seat back 30 in the present embodiment penetrates between a back surface and the surface of the seat back 30. The through hole constitutes an air flow passage for circulating an airflow between the ventilation passage member 60 and the electric blower 80.

The surface opening portion 32a with the through hole opened thereat is provided on the surface 31a of the seat back 30. The surface opening portion 32a is disposed at the center of the seating portion 91 on the surface 31a of the seat back 30. That is, the surface opening portion 32a is disposed at a portion of the surface 31a of the seat back 30 that overlaps with the seating center line Ta.

The ventilation passage member 60 of the present embodiment is provided with the air inlet/outlet 61D. The air inlet/outlet 61D is provided on the side of the surface 31a of the seat back 30 in the ventilation passage member 60. Specifically, the air inlet/outlet 61D is formed to be opened on the side of the surface 31a of the seat back 30 at the two tubes 61 on the center side in the vehicle width direction of the plurality of tubes 61. The air inlet/outlet 61D is disposed so as to overlap with the surface opening portion 32a with the through hole 32.

The ventilation passage member 60 is provided with a connection passage 70B that communicates with the air inlet/outlet 61D. The connection passage 70B communicates the air inlet/outlet 61D with the plurality of tubes 61. Specifically, the connection passage 70B communicates the two adjacent tubes 61 of the plurality of tubes 61.

The operation of the seat air conditioner of the present embodiment is substantially the same as that of the seat air conditioner of the above-mentioned seventh embodiment, and thus a description thereof is omitted.

### Other Embodiments

(1) In each of the above-mentioned first to tenth embodiments, an example has been described in which the seat air conditioner is used in the seat 10 of the vehicle. However, alternatively, the seat air conditioner may be used in any seat 10 other than those of the vehicles. The seat air conditioner may be used in, for example, any seat 10 used in general houses.
(2) In the above-mentioned second embodiment, an example has been described in which each of the front side ventilation port 63 and the rear side ventilation port 62 is formed in a belt shape. However, alternatively, the following configuration may be employed.

That is, the front side ventilation port 63 is formed in a V shape, and the rear side ventilation port 62 is formed in a U shape, so that the opening area of the front side ventilation port 63 is set larger than the opening area of the rear side ventilation port 62.

(3) In the above-mentioned fourth embodiment, an example has been described in which each of the upper side ventilation port 62A and the lower side ventilation port 63A is formed in a belt shape. However, alternatively, the following configuration may be employed.

That is, each of the upper side ventilation port 62A and the lower side ventilation port 63A is formed in a curved shape, and the opening area of the lower side ventilation port 63A is set larger than the opening area of the upper side ventilation port 62A.

(4) Each of the above-mentioned first to tenth embodiments has described an example of using the ventilation passage member 60 which constitutes the plurality of air flow passages by employing the plurality of tubes 61. However, alternatively, the ventilation passage member 60 constituting one air flow passage may be used.
(5) Each of the above-mentioned first, second, fifth, sixth, and ninth embodiments has described an example of using the ventilation passage member 60 which constitutes the air flow passages for circulating the airflow to the lower side. However, alternatively, the ventilation passage member 60 may be used to constitute any air flow passage for circulating the airflow to the right or left side in the vehicle width direction.

Alternatively, the ventilation passage member 60 may be used to constitute an air flow passage for circulating the airflow in the direction inclined in the vehicle width direction and also inclined in the vertical direction.

(6) Each of the above-mentioned third, fourth, seventh, eighth, and tenth embodiments has described an example of using the ventilation passage member 60 which constitutes the air flow passages for circulating the airflow to the upper side. However, alternatively, the ventilation passage member 60 may be used to constitute any air flow passage for circulating the airflow to the right or left side in the vehicle width direction.

Alternatively, the ventilation passage member 60 may be used to constitute an air flow passage for circulating the airflow in the direction inclined in the vehicle width direction and also inclined in the vertical direction.

(7) In the above-mentioned second embodiment, an example has been described in which the opening area of the front side ventilation port 63 is set larger than the opening area of the rear side ventilation port 62. However, alternatively, the following configuration may be employed.

That is, when the front side ventilation port 63 is located on the downstream side in the air flow direction with respect to the seating portion 90 and the rear side ventilation port 62 is located on the upstream side in the air flow direction with respect to the seating portion 90, the opening area of the rear side ventilation port 62 may be set larger than the opening area of the front side ventilation port 63.

(8) In the above-mentioned fourth embodiment, an example has been described in which the opening area of the lower side ventilation port 63A is set larger than the opening area of the upper side ventilation port 62A. However, alternatively, the following configuration may be employed.

That is, when the upper side ventilation port 62A is located on the downstream side in the air flow direction with respect to the seating portion 91 and the lower side ventilation port 63A is located on the upstream side in the air flow direction with respect to the seating portion 91, the opening area of the upper side ventilation port 62A may be set larger than the opening area of the lower side ventilation port 63A.

(9) In each of the above-mentioned first and second embodiments, an example has been described in which the airflow blown from the electric blower 80 through the ventilation passage member 60 is blown out of the rear side ventilation port 62 and the front side ventilation port 63 to the side of the user. However, alternatively, the following configuration may be employed.

That is, the airflow drawn from the user side through the rear side ventilation port 62 and the front side ventilation port 63 may be drawn into the electric blower 80 through the ventilation passage member 60.

In this case, the ventilation passage member 60 is provided with an air outlet, in place of the air inlet 61A, that discharges the airflow toward the electric blower 80 drawing the airflow.

Similarly, the above-mentioned fifth, sixth, and ninth embodiments are not limited to the case where the airflow blown from the electric blower 80 through the ventilation passage member 60 is blown out of the rear side ventilation port 62 and the front side ventilation port 63.

Also, in the above-mentioned fifth, sixth, and ninth embodiments, the airflow drawn from the side of the user through the rear side ventilation port 62 and the front side ventilation port 63 may be drawn into the electric blower 80 through the ventilation passage member 60.

Similarly, although each of the above-mentioned third and fourth embodiments has described an example in which the airflow blown from the electric blower 80 through the ventilation passage member 60 is blown out of the upper side ventilation port 62A and the lower side ventilation port 63A into the interior of the vehicle cabin, alternatively, the following configuration may be employed.

That is, the airflow drawn from the side of the user through the upper side ventilation port 62A and the lower side ventilation port 63A may be drawn into the electric blower 80 through the ventilation passage member 60.

In this case, the ventilation passage member 60 is provided with an air outlet which discharges the airflow toward the electric blower 80 drawing the airflow, in place of the air inlet 61B.

Similarly, the above-mentioned seventh, eighth, and tenth embodiments are not limited to the case where the airflow blown from the electric blower 80 through the ventilation passage member 60 is blown out of the upper side ventilation port 62A and the lower side ventilation port 63A into the interior of the vehicle cabin.

In the above-mentioned seventh, eighth, and tenth embodiments, the airflow drawn from the side of the user through the upper side ventilation port 62A and the lower side ventilation port 63A may be drawn into the electric blower 80 through the ventilation passage member 60.

(10) In each of the above-mentioned first and second embodiments, an example has been described in which the ventilation passage member 60 is provided with the rear side ventilation port 62, the front side ventilation port 63, and the air inlet 61A. However, additionally, another ventilation port may be provided on the front side in the vehicle traveling direction of the ventilation passage member 60 with respect to the front side ventilation port 63. Alternatively, another ventilation port may be provided on the rear side in the vehicle traveling direction of the ventilation passage member 60 with respect to the rear side ventilation port 62.

Specifically, a ventilation port (hereinafter referred to as a first ventilation port) that communicates between the inside and outside of each of the plurality of air flow passage is provided on the front side in the vehicle traveling direction of the ventilation passage member 60 with respect to the front side ventilation port 63.

Alternatively, a ventilation port (hereinafter referred to as a second ventilation port) that communicates between the inside and outside of each of the plurality of air flow passages is provided on the rear side in the vehicle traveling direction of the ventilation passage member 60 with respect to the rear side ventilation port 62.

Here, the airflow supplied from the electric blower 80 to the ventilation passage member 60 through the connecting portion 70 is blown from the first ventilation port, the second ventilation port, the front side ventilation port 63, and the rear side ventilation port 62 in the ventilation passage member 60.

In this case, the plurality of tubes of the ventilation passage member 60 need to be formed so as to close the area between the inside and outside of each of the plurality of air flow passages, over the entire region of the ventilation passage member 60 between the rear side ventilation port 62 and the front side ventilation port 63.

The vehicle seat air conditioner is not limited to the configuration in which the airflow blown from the electric blower 80 to the ventilation passage member 60 is blown from the front side ventilation port 63 and the rear side ventilation port 62 into the interior of the vehicle cabin. The airflow from the interior of the vehicle cabin may be drawn by the electric blower 80 through the first ventilation port, the second ventilation port, the rear side ventilation port 62, and the front side ventilation port 63 in the ventilation passage member 60.

Also, in this case, the plurality of tubes of the ventilation passage member 60 need to be formed so as to close the area between the inside and outside of each of the plurality of air flow passages, over the entire region of the ventilation passage member 60 between the rear side ventilation port 62 and the front side ventilation port 63.

Similarly, also in the above-mentioned fifth, sixth, seventh, and eighth embodiments, another ventilation port may be provided on the front side in the vehicle traveling direction of the ventilation passage member 60 with respect to the front side ventilation port 63, or another ventilation port may be provided on the rear side in the vehicle traveling direction of the ventilation passage member 60 with respect to the rear side ventilation port 62.

(11) In each of the above-mentioned third and fourth embodiments, an example has been described in which the ventilation passage member 60 is provided with the upper side ventilation port 62A, the lower side ventilation port 63A, and the air inlet 61B. However, additionally, another ventilation port may be provided on the upper side in the vertical direction of the ventilation passage member 60 with respect to the upper side ventilation port 62A, or another ventilation port may be provided on the lower side in the vertical direction of the ventilation passage member 60 with respect to the lower side ventilation port 63A.

Specifically, a ventilation port (hereinafter referred to as a third ventilation port) that communicates between the inside and outside of each of the plurality of air flow passages is provided on the upper side in the vertical direction of the ventilation passage member 60 with respect to the upper side ventilation port 62A.

Alternatively, a ventilation port (hereinafter referred to as a fourth ventilation port) that communicates between the inside and outside of each of the plurality of air flow passages is provided on the lower side in the vertical direction of the ventilation passage member 60 with respect to the lower side ventilation port 63A.

Here, the airflow supplied from the electric blower 80 to the ventilation passage member 60 through the connecting portion 70 is blown from the third ventilation port, the fourth ventilation port, the upper side ventilation port 62A, and the lower side ventilation port 63A of the ventilation passage member 60.

In this case, the plurality of tubes of the ventilation passage member 60 need to be formed so as to close the area between the inside and outside of each of the plurality of air flow passages, over the entire region of the ventilation passage member 60 between the upper side ventilation port 62A and the lower side ventilation port 63A.

The vehicle seat air conditioner is not limited to the configuration in which the airflow blown from the electric blower 80 to the ventilation passage member 60 is blown from the third ventilation port, the fourth ventilation port, the upper side ventilation port 62A, and the lower side ventilation port 63A into the interior of the vehicle cabin. The airflow from the interior of the vehicle cabin may be drawn by the electric blower 80 through the third ventilation port, the fourth ventilation port, the upper side ventilation port 62A, and the lower side ventilation port 63A of the ventilation passage member 60.

Also, in this case, the plurality of tubes of the ventilation passage member 60 need to be formed so as to close the area between the inside and outside of each of the plurality of air flow passages, over the entire region of the ventilation passage member 60 between the upper side ventilation port 62A and the lower side ventilation port 63A.

(12) The front side ventilation port 63 and the rear side ventilation port 62 in the above-mentioned first and second embodiments may be provided with an opening with various shapes, such as a slit shape or a circular shape that extends in the vehicle width direction.

Similarly, also in the above-mentioned fifth, sixth, seventh, and eighth embodiments, an opening portion with various shapes, such as a slit shape or a circular shape that extends in the vehicle width direction, may be provided in or as the front side ventilation port 63 or the rear side ventilation port 62.

(13) The upper side ventilation port 62A and the lower side ventilation port 63A in the above-mentioned third and fourth embodiments may be provided with an opening with various shapes, such as a slit shape or a circular shape that extends in the vehicle width direction.
(14) In each of the above-mentioned second and ninth embodiments, an example has been described in which the front side seating end 90a is disposed in the position that overlaps with the front side ventilation port 63, and the rear side seating end 90b is disposed in the position on the front side in the vehicle traveling direction with respect to the rear side ventilation port 62. However, alternatively, the following configuration (a) or (b) may be taken.

(a) The front side seating end 90a is disposed in the position on the rear side in the vehicle traveling direction with respect to the front side ventilation port 63, and the rear side seating end 90b is disposed in the position that overlaps with the rear side ventilation port 62.

(b) The front side seating end 90a is disposed in the position that overlaps with the front side ventilation port 63, and the rear side seating end 90b is disposed in the position that overlaps with the rear side ventilation port 62.

In the case of the above-mentioned configurations (a) and (b), the rear side ventilation port 62 and the front side ventilation port 63 are disposed such that the seating portion 90 overlaps with the portion of the ventilation passage member 60 located between the rear side ventilation port 62 and the front side ventilation port 63.

Also in the above-mentioned fifth and sixth embodiments, the rear side ventilation port 62 or the front side ventilation port 63 may be disposed in the same manner as that of the above-mentioned configuration (a) or (b).

(15) In each of the above-mentioned fourth and tenth embodiments, an example has been described in which the upper side seating end 91a is disposed in the position that overlaps with the upper side ventilation port 62A, and the lower side seating end 91b is disposed in the position on the upper side in the vertical direction with respect to the lower side ventilation port 63A. However, alternatively, the following configuration (c) or (d) may be taken.

(c) The upper side seating end 91a is disposed in the position on the lower side in the vertical direction with respect to the upper side ventilation port 62A, and the lower side seating end 91b is disposed in the position that overlaps with the lower side ventilation port 63A.

(d) The upper side seating end 91a is disposed in the position that overlaps with the upper side ventilation port 62A, and the lower side seating end 91b is disposed in the position that overlaps with the lower side ventilation port 63A.

In the case of the above-mentioned configuration (c) or (d), the upper side ventilation port 62A and the lower side ventilation port 63A are disposed such that the seating portion 91 overlaps with the portion of the ventilation passage member 60 located between the upper side ventilation port 62A and the lower side ventilation port 63A.

Also in the above-mentioned seventh and eighth embodiments, the upper side ventilation port 62A or the lower side ventilation port 63A may be disposed in the same manner as that of the above-mentioned configuration (c) or (d).

(16) In the above-mentioned first embodiment, an example has been described in which the seating portion 90 overlaps with a portion of the ventilation passage member 60 located between the rear side ventilation port 62 and the front side ventilation port 63. However, alternatively, the seating portion 90 may be disposed at a portion within the ventilation passage member 60, avoiding a portion located between the rear side ventilation port 62 and the front side ventilation port 63.
(17) In the above-mentioned third embodiment, an example has been described in which the seating portion 91 overlaps a portion between the lower side ventilation port 63A and the upper side ventilation port 62A. However, alternatively, the seating portion 91 may be disposed at any other portion that avoids the portion between the lower side ventilation port 63A and the upper side ventilation port 62A.
(18) In the above-mentioned second embodiment, an example has been described in which the front side ventilation port 63 is disposed in the portion of the ventilation passage member 60 that overlaps with the seating portion 90. However, alternatively, the following configuration may be employed.

That is, in the above-mentioned second embodiment, the rear side ventilation port 62 is disposed in a portion, which avoids the seating portion 90, within the ventilation passage member 60. The front side ventilation port 63 is disposed in a portion, which avoids the seating portion 90, within the ventilation passage member 60.

(19) In the above-mentioned fourth embodiment, an example has been described in which the upper side ventilation port 62A is disposed in the portion of the ventilation passage member 60 that overlaps with the seating portion 91. However, alternatively, the following configuration may be employed.

That is, in the above-mentioned fourth embodiment, the upper side ventilation port 62A is disposed in the portion, which avoids the seating portion 91, within the ventilation passage member 60. The lower side ventilation port 63A is disposed in the portion, which avoids the seating portion 91, within the ventilation passage member 60.

(20) In the above-mentioned second embodiment, an example has been described in which the ventilation passage member 60 and the electric blower 80 are connected together using the connecting portion 70. Alternatively, like the above-mentioned fifth embodiment, a seat air conditioner may be configured to employ the through hole 22 of the seat cushion 20 to thereby connect the ventilation passage member 60 and the electric blower 80 together through the through hole 22.
(21) In the above-mentioned fourth embodiment, an example has been described in which the ventilation passage member 60 and the electric blower 80 are connected together using the connecting portion 70. Alternatively, like the above-mentioned seventh embodiment, a seat air conditioner may be configured to employ the through hole 32 of the seat back 30 to thereby connect the ventilation passage member 60 and the electric blower 80 together through the through hole 32.
(22) The above-mentioned ninth embodiment has described an example of using the belt-shaped front side ventilation port 63 that extends in the vehicle width direction. However, alternatively, a V-shaped front side ventilation port 63 that is formed to be convex rearward in the vehicle traveling direction may be used, like the above-mentioned first embodiment.
(23) The above-mentioned ninth embodiment has described an example of using the belt-shaped rear side ventilation port 62 that extends in the vehicle width direction. However, alternatively, a rear side ventilation port 62 that is formed in a U shape may be used, like the above-mentioned first embodiment.
(24) The above-mentioned tenth embodiment has described an example of using the belt-shaped lower side ventilation port 63A that extends in the vehicle width direction. However, alternatively, a lower side ventilation port 63A that is formed in a curved shape may be used, like the above-mentioned third embodiment.
(25) The above-mentioned tenth embodiment has described an example of using the rectangle upper side ventilation port 62A that extends in the vehicle width direction. However, alternatively, an upper side ventilation port 62A that is formed in a curved shape may be used, like the above-mentioned third embodiment.
(26) In each of the above-mentioned fifth, sixth, and tenth embodiments, an example has been described in which the center line F of the seat cushion 20 and the seating center line Fa are the same. However, alternatively, the center line F of the seat cushion 20 and the seating center line Fa may be offset from each other.
(27) In each of the above-mentioned seventh, eighth, and eleventh embodiments, an example has been described in which the center line T of the seat back 30 and the seating center line Ta are the same. However, alternatively, the center line T of the seat back 30 and the seating center line Ta may be offset from each other.
(28) The present disclosure is not limited to the above-mentioned embodiments, and various modifications and changes can be made to the embodiments. The above-mentioned respective embodiments are not irrelevant to each other, and any combination of the embodiments may be implemented as appropriate, except when the combination seems obviously impossible. It is obvious that in the above-mentioned respective embodiments, the elements included in the embodiments are not necessarily essential particularly unless otherwise specified to be essential, except when clearly considered to be essential in principle, and the like. When referring to a specific number about a component in the above-mentioned embodiments, including the number, a numerical value, an amount, a range, and the like of the component, the component should not be limited to the specific number particularly unless otherwise specified to be essential, except when clearly limited to the specific number in principle, and the like. When referring to the shape of a component, the positional relationship between components, and the like in the above-mentioned embodiments, the component should not be limited to the shape, positional relationship, or the like, unless otherwise specified, except when limited to the specific shape, positional relationship in principle, and the like.

According to a first aspect described in a part or all of the above-mentioned first to tenth embodiments and other embodiments, the seat air conditioner is used for any seat including a seat cushion that supports the buttocks of a user on its surface.

The seat air conditioner includes a ventilation passage member disposed on the surface of the seat cushion and configured to form an air flow passage through which an air flows in a predetermined direction along the surface. The ventilation passage member includes a first ventilation port and a second ventilation port through which an inside of the air flow passage communicates with an outside of the air flow passage. The ventilation passage member is elastically deformed by a pressure applied from the buttocks of the user.

The first ventilation port is disposed on one side in the predetermined direction with respect to the second ventilation port, and an airflow blown out of a blower or to be drawn into the blower flows through the air flow passage, the first ventilation port, and the second ventilation port.

The first ventilation port and the second ventilation port are disposed in positions, which avoid a seating portion, within the ventilation passage member, when the user sits on the seat and the seating portion is a portion of the seat cushion that mainly supports the buttocks of the user.

The ventilation passage member is formed so as to close an area between the inside and outside of the air flow passage, over an entire region of the ventilation passage member between the first ventilation port and the second ventilation port.

Thus, the region of the ventilation passage member between the first ventilation port and the second ventilation port is prevented from being collapsed due to its elastic deformation even when any pressure is applied from the buttocks of the user to the region of the ventilation passage member between the first ventilation port and the second ventilation port. Consequently, the airflow can pass through each of the first ventilation port and the second ventilation port. Therefore, the seat air conditioner can be provided which prevents the user from feeling less comfortable.

According to a second aspect, the ventilation passage member is provided with an air inlet/outlet into which the airflow blown out of the blower flows or from which the airflow is discharged toward the blower drawing the airflow. The ventilation passage member is formed such that a portion of the ventilation passage member, except for the first ventilation port, the second ventilation port, and the air inlet/outlet, entirely closes the area between the inside and outside of the air flow passage.

Thus, the amount of air blown out of the first ventilation port and the second ventilation port can be ensured.

According to a third aspect, a seat air conditioner is used in a seat including a seat cushion for supporting the buttocks of a user on its surface.

The seat air conditioner includes a ventilation passage member disposed on the surface of the seat cushion and configured to form an air flow passage through which an airflow circulates in a predetermined direction along the surface. The ventilation passage member includes a first ventilation port and a second ventilation port through which the airflow is blown out of the air flow passage to a side of the user or through which the airflow is drawn from the side of the user to the air flow passage. In addition, the ventilation passage member is elastically deformed by a pressure applied from the buttocks of the user.

The first ventilation port is disposed on one side in the predetermined direction with respect to the second ventilation port, and the seat cushion is provided with a through hole through which the airflow blown out of a blower or the airflow drawn into the blower circulates.

An air inlet/outlet is formed in a portion of the ventilation passage member that overlaps with the through hole of the seat cushion. The airflow blown out of the blower or the airflow drawn into the blower circulates between the air flow passage and the blower through the air inlet/outlet and the through hole.

The first ventilation port and the second ventilation port are disposed in positions, which avoid a seating portion, within the ventilation passage member when the user sits on the seat and the seating portion is a portion of the seat cushion that mainly supports the buttocks of the user.

No ventilation port is provided between the first ventilation port and the second ventilation port in the ventilation passage member so as to blow the airflow from the air flow passage to the user or to draw the airflow from the side of the user into the air flow passage.

According to a fourth aspect, a seat air conditioner is used in a seat including a seat cushion for supporting the buttocks of a user on its surface. The seat air conditioner includes a ventilation passage member disposed on the surface of the seat cushion and configured to form an air flow passage through which an airflow circulates in a predetermined direction along the surface.

The ventilation passage member includes a first ventilation port and a second ventilation port through which the airflow is blown out of the air flow passage to a side of the user or through which the airflow is drawn from the side of the user to the air flow passage. In addition, the ventilation passage member is elastically deformed by a pressure applied from the buttocks of the user.

The first ventilation port is disposed on one side in the predetermined direction with respect to the second ventilation port, and an airflow blown out of a blower or drawn into the blower circulates through the air flow passage.

When the user sits on the seat, a seating portion is a portion of the seat cushion that mainly supports the buttocks of the user. One side end of the seating portion is an end of the seating portion located on one side in the predetermined direction, while the other side end of the seating portion is an end of the seating portion located on the other side in the predetermined direction.

The one side end of the seating portion is disposed in a position that overlaps with the first ventilation port or in a position located on the other side in the predetermined direction with respect to the first ventilation port, while the other side end of the seating portion is disposed in a position that overlaps with the second ventilation port or in a position located on one side in the predetermined direction with respect to the second ventilation port.

No ventilation port is provided between the first ventilation port and the second ventilation port in the ventilation passage member so as to prevent the airflow from blowing from the air flow passage to the user or to prevent the air flow from blowing from the side of the user into the air flow passage.

Thus, a region of the ventilation passage member between the first ventilation port and the second ventilation port is prevented from being collapsed due to its elastic deformation even when any pressure is applied from the thighs or buttocks of the user to the region of the ventilation passage member between the first ventilation port and the second ventilation port. Consequently, the airflow can pass through each of the first ventilation port and the second ventilation port. Therefore, the seat air conditioner can be provided which prevents the user from feeling less comfortable.

According to a fifth aspect, the seat cushion is provided with a through hole through which the airflow blown out of a blower or the airflow drawn into the blower circulates. An air inlet/outlet is formed in a portion of the ventilation passage member that overlaps with the through hole of the seat cushion. The airflow blown out of the blower or the airflow drawn into the blower circulates between the air flow passage and the blower through the air inlet/outlet and the through hole.

According to a sixth aspect, the through hole is opened in a portion of the seat cushion that overlaps with the seating portion.

According to a seventh aspect, the seat is disposed in an interior of a vehicle cabin of a vehicle. When a seating center line is an imaginary line that extends in a direction orthogonal to the vehicle traveling direction while passing through a midpoint in the vehicle traveling direction of the seating portion, the through hole is opened in a portion of the surface of the seat cushion located on a front side in a vehicle traveling direction with respect to the seating center line.

According to an eighth aspect, the seat is disposed in an interior of a vehicle cabin of a vehicle. The ventilation passage member forms the air flow passage through which the airflow circulates to one side in a vehicle traveling direction as the predetermined direction. A center line is an imaginary line that extends in a direction orthogonal to the vehicle traveling direction while passing through the midpoint in the vehicle traveling direction of the surface of the seat cushion.

The first ventilation port is a front side ventilation port located on a front side in the vehicle traveling direction of the seat cushion with respect to the center line. The second ventilation port is a rear side ventilation port located on a rear side in the vehicle traveling direction of the seat cushion with respect to the center line.

Thus, the airflow can be blown out of each of the front side ventilation port and the rear side ventilation port.

According to a ninth aspect, the front side ventilation port is formed in a V shape that extends forward in the vehicle traveling direction, from a center in a vehicle width direction toward one side in the vehicle width direction of the ventilation passage member, and also extends forward in the vehicle traveling direction, from the center in the vehicle width direction toward the other side in the vehicle width direction of the ventilation passage member.

Thus, the airflow from the front side ventilation port can be blown out along the inner crotch of the user.

According to a tenth aspect, the rear side ventilation port is formed in a U shape that extends forward in the vehicle traveling direction, from a center in a vehicle width direction as toward one side in the vehicle width direction of the ventilation passage member, and also extends forward in the vehicle traveling direction, from the center in the vehicle width direction as toward the other side in the vehicle width direction of the ventilation passage member.

Thus, the airflow can be blown from the rear side ventilation port to the waist of the user.

According to an eleventh aspect, an opening area of the front side ventilation port is larger than an opening area of the rear side ventilation port.

Thus, the amount of air blown out of the front side ventilation port can be ensured.

According to a twelfth aspect, a seat air conditioner is used in a seat including a seat back for supporting a back of a user on a surface. The seat air conditioner includes a ventilation passage member disposed on the surface of the seat back and configured to form an air flow passage through which an airflow circulates in a predetermined direction along the surface. The ventilation passage member includes a first ventilation port and a second ventilation port which communicate between an inside and an outside of the air flow passage and is elastically deformed by a pressure applied from the back of the user.

The first ventilation port is disposed on one side in the predetermined direction of the ventilation passage member with respect to the second ventilation port.

An airflow blown out of a blower or drawn into the blower circulates through the air flow passage, the first ventilation port, and the second ventilation port.

The first ventilation port and the second ventilation port are disposed in portions, which avoid a seating portion, within the ventilation passage member, when the user sits on the seat and the seating portion is a portion of the seat back that mainly supports the back of the user.

The ventilation passage member is formed so as to close an area between the inside and outside of the air flow passage, over an entire region of the ventilation passage member between the first ventilation port and the second ventilation port.

According to a thirteenth aspect, the ventilation passage member is provided with an air inlet/outlet into which the airflow blown out of the blower flows or from which the airflow is discharged toward the blower drawing the airflow. The ventilation passage member is formed such that a portion of the ventilation passage member, except for the first ventilation port, the second ventilation port, and the air inlet/outlet, entirely closes the area between the inside and outside of the air flow passage.

Thus, the amount of air blown out of the first ventilation port and the second ventilation port can be ensured.

According to a fourteenth aspect, a seat air conditioner is used in a seat including a seat back for supporting a back of a user on its surface. The seat air conditioner includes a ventilation passage member disposed on the surface of the seat back and configured to form an air flow passage through which an airflow circulates along the surface.

The ventilation passage member includes a first ventilation port and a second ventilation port through which the airflow is blown out of the air flow passage to a side of the user or through which the airflow is drawn from the side of the user to the air flow passage. In addition, the ventilation passage member is elastically deformed by a pressure applied from the back of the user.

The first ventilation port is disposed on one side in a predetermined direction with respect to the second ventilation port, and the seat back is provided with a through hole through which the airflow blown out of a blower or the airflow drawn into the blower circulates.

An air inlet/outlet is formed in a portion of the ventilation passage member that overlaps with the through hole of the seat back, and the airflow blown out of the blower or the airflow drawn into the blower circulates between the air flow passage and the blower through the air inlet/outlet and the through hole.

The first ventilation port and the second ventilation port are disposed in portions, which avoid a seating portion, within the ventilation passage member, when the user sits on the seat and the seating portion is a portion of the seat back that mainly supports the back of the user.

No ventilation port is provided between the first ventilation port and the second ventilation port in the ventilation passage member so as to blow the airflow from the air flow passage to the user or to draw the airflow from the side of the user into the air flow passage.

According to a fifteenth aspect, a seat air conditioner is used in a seat including a seat back for supporting a back of a user on its surface.

The seat air conditioner includes a ventilation passage member disposed on the surface of the seat back and configured to form an air flow passage through which an airflow circulates in a predetermined direction along the surface.

The ventilation passage member includes a first ventilation port and a second ventilation port through which the airflow is blown out of the air flow passage to a side of the user or through which the airflow is drawn from the side of the user to the air flow passage. In addition, the ventilation passage member is elastically deformed by a pressure applied from the back of the user.

The first ventilation port is disposed on one side in the predetermined direction with respect to the second ventilation port, and an airflow blown out of a blower or drawn into the blower circulates through the air flow passage.

When the user sits on the seat, a seating portion is a portion of the seat back that mainly supports the back of the user. One side end of the seating portion is an end of the seating portion located on one side in the predetermined direction, while the other side end of the seating portion is an end of the seating portion located on the other side in the predetermined direction.

The one side end of the seating portion is disposed in a position that overlaps with the first ventilation port or in a position located on the other side in the predetermined direction with respect to the first ventilation port, while the other side end of the seating portion is disposed in a position that overlaps with the second ventilation port or in a position located on one side in the predetermined direction with respect to the second ventilation port.

No ventilation port is provided between the first ventilation port and the second ventilation port in the ventilation passage member so as to blow the airflow from the air flow passage to the user or to draw the airflow from the side of the user into the air flow passage.

According to a sixteenth aspect, the seat back is provided with a through hole through which the airflow blown out of a blower or the airflow drawn into the blower circulates. An air inlet/outlet is formed in a portion of the ventilation passage member that overlaps with the through hole of the seat back.

The airflow blown out of the blower or the airflow drawn into the blower circulates between the air flow passage and the blower through the air inlet/outlet and the through hole.

According to a seventeenth aspect, the through hole is disposed in a portion of the surface of the seat back that overlaps with the seating portion.

According to an eighteenth aspect, a seating center line is an imaginary line that extends in a direction orthogonal to a vertical direction while passing through a midpoint in the vertical direction of the seating portion. The through hole is opened in a portion of the surface of the seat back located on an upper side with respect to the seating center line.

According to a nineteenth aspect, the ventilation passage member forms an air flow passage through which the airflow circulates to one side in a vertical direction as the predetermined direction. A center line is an imaginary line that extends in a direction orthogonal to the vertical direction while passing through the midpoint in the vertical direction of the surface of the seat back. The first ventilation port is an upper side ventilation port located on an upper side in the vertical direction of the surface of the seat back with respect to the center line. The second ventilation port is a lower side ventilation port located on a lower side in the vertical direction of the surface of the seat back with respect to the center line.

Thus, the airflow can be blown out of each of the upper side ventilation port and the lower side ventilation port.

According to a twentieth aspect, an opening area of the upper side ventilation port is larger than an opening area of the lower side ventilation port.

Thus, the amount of air blown out of the upper side ventilation port can be ensured.

According to a twenty-first aspect, the upper side ventilation port is formed in a curved shape that extends downward in the vertical direction, from a center in a vehicle width direction toward one side in the vehicle width direction of the ventilation passage member, and also extends downward in the vertical direction, from the center in the vehicle width direction toward the other side in the vehicle width direction of the ventilation passage member.

Thus, the airflow can be blown out of the upper side ventilation port to both shoulders and neck of the user.

According to a twenty-second aspect, the lower side ventilation port is formed in a curved shape that extends upward in the vertical direction, from the center in the vehicle width direction toward one side in the vehicle width direction of the ventilation passage member, and also extends upward in the vertical direction, from the center in the vehicle width direction toward the other side in the vehicle width direction of the ventilation passage member.

Thus, the airflow can be blown out of the lower side ventilation port to the waist and buttocks of the user.

According to a twenty-third aspect, when the airflow is blown from the upper side ventilation port to both shoulders and neck of the user, and the other airflow is blown from the lower side ventilation port to the waist and buttocks of the user, the upper side ventilation port and the lower side ventilation port are desirably formed in the following manner.

That is, according to the twenty-third aspect, a first reference line is an imaginary line that extends in the vehicle width direction while passing through the uppermost side in the vertical direction of the upper side ventilation port. A second reference line is an imaginary line that extends in the vehicle width direction while passing through the lowermost side in the vertical direction of the upper side ventilation port. La is a distance between the first reference line and the second reference line, and a third reference line is an imaginary line that extends in the vehicle width direction while passing through the uppermost side in the vertical direction of the lower side ventilation port.

A fourth reference line is an imaginary line that extends in the vehicle width direction while passing through the lowermost side in the vertical direction of the lower side ventilation port. Lb is a distance between the third reference line and the fourth reference line, and the upper side ventilation port and the lower side ventilation port are formed to satisfy the relationship of Lb<La.

According to a twenty-fourth aspect, the ventilation passage member forms a plurality of the air flow passages through which the airflow circulates along the surface.

According to a twenty-fifth aspect, the first ventilation port and the second ventilation port are disposed such that the seating portion overlaps with a portion of the ventilation passage member located between the first ventilation port and the second ventilation port.

What is claimed is:

1. A seat air conditioner to be used for a seat including a seat cushion for supporting buttocks of a user on a surface of the seat cushion, the seat air conditioner comprising
a ventilation passage member disposed on the surface of the seat cushion and configured to form an air flow passage through which an air flows in a predetermined direction along the surface, the ventilation passage member including a first ventilation port and a second ventilation port that are configured to communicate between an inside and an outside of the air flow passage, the ventilation passage member being elastically deformed by a pressure applied from the buttocks of the user, wherein
the first ventilation port is disposed on one side in the predetermined direction with respect to the second ventilation port,
the air flow passage, the first ventilation port and the second ventilation port are configured to flow therein the air blown from a blower or to be drawn to the blower,
the first ventilation port and the second ventilation port are arranged in positions within the ventilation passage member, avoiding a seating portion of the seat cushion, wherein the seating portion mainly supports the buttocks of the user when the user sits on the seat, and
the ventilation passage member is configured to close an area between the inside and outside of the air flow passage, over an entire region of the ventilation passage member between the first ventilation port and the second ventilation port.

2. The seat air conditioner according to claim 1, wherein
the ventilation passage member is provided with an air inlet/outlet into which the air blown out of the blower flows or from which the air is discharged to be drawn to the blower, and
the ventilation passage member is formed such that a portion of the ventilation passage member, except for the first ventilation port, the second ventilation port, and the air inlet/outlet, entirely closes the area between the inside and outside of the air flow passage.

3. A seat air conditioner to be used for a seat including a seat cushion for supporting buttocks of a user on a surface of the seat cushion, the seat air conditioner comprising:
a ventilation passage member disposed on the surface of the seat cushion and configured to form an air flow passage through which an air flows in a predetermined direction along the surface, the ventilation passage member including a first ventilation port and a second ventilation port through which the air is blown out of the air flow passage to a side of the user or through which the air is drawn from the side of the user to the air flow passage, the ventilation passage member being elastically deformed by a pressure applied from the buttocks of the user, wherein
the first ventilation port is separated from the second ventilation port in the predetermined direction,
the seat cushion is provided with a through hole through which the air blown out of a blower or the air drawn into the blower flows,
an air inlet/outlet is provided in a portion of the ventilation passage member, the portion overlapping with the through hole of the seat cushion,
the air flow passage is provided to flow therein the air blown out of the blower or the air to be drawn into the blower, through the air inlet/outlet and the through hole,
the first ventilation port and the second ventilation port are arranged in positions within the ventilation passage member, avoiding a seating portion of the seat cushion, wherein the seating portion mainly supports the buttocks of the user when the user sits on the seat, and
the ventilation passage member located between the first ventilation port and the second ventilation port is not provided with a ventilation port through which an air flow is blown from the air flow passage to a side of the user or an air flow is drawn from the side of the user into the air flow passage.

4. A seat air conditioner to be used for a seat including a seat cushion for supporting buttocks of a user on a surface of the seat cushion, the seat air conditioner comprising
a ventilation passage member disposed on the surface of the seat cushion and configured to form an air flow passage through which an air flows in a predetermined direction along the surface of the seat cushion, the ventilation passage member including a first ventilation port and a second ventilation port through which the air is blown out of the air flow passage to a side of the user or through which the air is drawn from the side of the user to the air flow passage, the ventilation passage member being elastically deformed by a pressure applied from the buttocks of the user, wherein
the first ventilation port and the second ventilation port are separated from each other in the predetermined direction,
the air flow passage is configured to flow therein air blown out of a blower or to be drawn into the blower,
the seat cushion has a seating portion that mainly supports the buttocks of the user, the seating portion has a first end portion located on one end side in the predetermined direction, and a second end portion located on the other end side in the predetermined direction,
the first end portion of the seating portion is positioned to overlap with the first ventilation port or with a position on the other end side in the predetermined direction with respect to the first ventilation port, while the second end portion of the seating portion is positioned to overlap with the second ventilation port or with a position on one end side in the predetermined direction with respect to the second ventilation port, and
the ventilation passage member located between the first ventilation port and the second ventilation port is not provided with a ventilation port through which an air flow is blown from the air flow passage to a side of the user or an air flow is drawn from the side of the user into the air flow passage.

5. The seat air conditioner according to claim 4, wherein
the seat cushion is provided with a through hole through which the air blown out of the blower or the air to be drawn into the blower flows,
the ventilation passage member is provided with an air inlet/outlet at a portion overlapping with the through hole of the seat cushion, and
the air blown out of the blower or the air to be drawn into the blower flows to the air flow passage through the air inlet/outlet and the through hole.

6. The seat air conditioner according to claim 3, wherein
the through hole is open in a portion of the seat cushion, overlapping with the seating portion.

7. The seat air conditioner according to claim 3, wherein
the seat is disposed in an interior of a vehicle cabin of a vehicle, and
the through hole is open in a portion of the surface of the seat cushion, on a front side in the vehicle traveling direction with respect to a seating center line that is an imaginary line extending in a direction orthogonal to the vehicle traveling direction while passing through a midpoint in the vehicle traveling direction of the seating portion.

8. The seat air conditioner according to claim 1, wherein
the seat is disposed in an interior of a vehicle cabin of a vehicle,
the ventilation passage member forms the air flow passage through which the air flows in a vehicle traveling direction as the predetermined direction, and
when a center line is an imaginary line that extends in a direction orthogonal to the vehicle traveling direction while passing through a midpoint in the vehicle traveling direction of the surface of the seat cushion, the first ventilation port is a front side ventilation port located on a front side in the vehicle traveling direction of the seat cushion with respect to the center line, and the second ventilation port is a rear side ventilation port located on a rear side in the vehicle traveling direction of the seat cushion with respect to the center line.

9. The seat air conditioner according to claim 8, wherein
the front side ventilation port is formed in a V shape that extends forward in the vehicle traveling direction, from a center in a vehicle width direction as toward one side in the vehicle width direction of the ventilation passage member, and extends forward in the vehicle traveling direction, from the center in the vehicle width direction as toward the other side in the vehicle width direction of the ventilation passage member.

10. The seat air conditioner according to claim 8, wherein
the rear side ventilation port is formed in a U shape that extends forward in the vehicle traveling direction, from a center in a vehicle width direction as toward one side in the vehicle width direction of the ventilation passage member, and extends forward in the vehicle traveling direction, from the center in the vehicle width direction as toward the other side in the vehicle width direction of the ventilation passage member.

11. The seat air conditioner according to claim 10, wherein
an opening area of the front side ventilation port is larger than an opening area of the rear side ventilation port.

12. A seat air conditioner to be used for a seat including a seat back for supporting a back of a user on a surface of the seat back, the seat air conditioner comprising
a ventilation passage member disposed on the surface of the seat back and configured to form an air flow passage through which an air flows in a predetermined direction along the surface, the ventilation passage member including a first ventilation port and a second ventilation port that are configured to communicate between an inside and an outside of the air flow passage, the ventilation passage member being elastically deformed by a pressure applied from the back of the user, wherein
the first ventilation port is disposed on one side in the predetermined direction of the ventilation passage member with respect to the second ventilation port,
the air flow passage, the first ventilation port, and the second ventilation port are configured such that an air blown out of a blower or to be drawn into the blower flows through the air flow passage, the first ventilation port, and the second ventilation port,
the first ventilation port and the second ventilation port are disposed in portions within the ventilation passage member, avoiding a seating portion of the seat back, that mainly supports the back of the user when the user sits on the seat and the seating portion, and
the ventilation passage member is configured to close an area between the inside and outside of the air flow passage, over an entire region of the ventilation passage member between the first ventilation port and the second ventilation port.

13. The seat air conditioner according to claim 12, wherein
the ventilation passage member is provided with an air inlet/outlet into which the air blown out of the blower flows or from which the air is discharged to be drawn to the blower, and
the ventilation passage member is formed such that a portion of the ventilation passage member, except for the first ventilation port, the second ventilation port, and the air inlet/outlet, entirely closes the area between the inside and outside of the air flow passage.

14. A seat air conditioner to be used for a seat including a seat back for supporting a back of a user on a surface of the seat back, the seat air conditioner comprising
a ventilation passage member disposed on the surface of the seat back and configured to form an air flow passage through which an air flows along the surface, the ventilation passage member including a first ventilation port and a second ventilation port through which the air is blown out of the air flow passage to a side of the user or through which the air is drawn from the side of the user to the air flow passage, the ventilation passage member being elastically deformed by a pressure applied from the back of the user, wherein
the first ventilation port is disposed on one side in a predetermined direction with respect to the second ventilation port,
the seat back is provided with a through hole through which the air blown out of a blower or the air to be drawn into the blower flows,
an air inlet/outlet is formed in a portion of the ventilation passage member, overlapping with the through hole of the seat back,
the air blown out of the blower or the air to be drawn into the blower flows to the air flow passage through the air inlet/outlet and the through hole,
the first ventilation port and the second ventilation port are disposed in positions within the ventilation passage member, avoiding a seating portion of the seat back, that mainly supports the back of the user when the user sits on the seat, and
the ventilation passage member located between the first ventilation port and the second ventilation port is not provided with a ventilation port through which the air flows from the air flow passage to the user or to draw the air flowing from the side of the user into the air flow passage.

15. A seat air conditioner to be used for a seat including a seat back for supporting a back of a user on a surface of the seat back, the seat air conditioner comprising
a ventilation passage member disposed on the surface of the seat back and configured to form an air flow passage through which an air flows in a predetermined direction along the surface, the ventilation passage member including a first ventilation port and a second ventilation port through which the air is blown out of the air flow passage to a side of the user or through which the air drawn from the side of the user to the air flow passage flows, the ventilation passage member being elastically deformed by a pressure applied from the back of the user, wherein
the first ventilation port and the second ventilation port are disposed to be separated from each other in the predetermined direction,
the air flow passage is configured to flow therein air blown out of a blower or to be drawn into the blower,
the seat back has a seating portion that mainly supports the back of the user, the seating portion has a first end portion located on one end side in the predetermined direction, and a second end portion located on the other end side in the predetermined direction,
the first end portion of the seating portion is positioned to overlap with the first ventilation port or with a position on the other end side in the predetermined direction with respect to the first ventilation port, while the second end portion of the seating portion is positioned to overlap with the second ventilation port or with a position on one end side in the predetermined direction with respect to the second ventilation port, and
the ventilation passage member located between the first ventilation port and the second ventilation port is not provided with a ventilation port through which an air flow is blown from the air flow passage to a side of the user or an air flow is drawn from the side of the user into the air flow passage.

16. The seat air conditioner according to claim 15, wherein
the seat back is provided with a through hole through which the air blown out of the blower or the air to be drawn into the blower flows,
the ventilation passage member is provided with an air inlet/outlet at a portion overlapping with the through hole of the seat back, and
the air blown out of the blower or the air to be drawn into the blower flows to the air flow passage through the air inlet/outlet and the through hole.

17. The seat air conditioner according to claim 14, wherein
the through hole is open in a portion of the seat back, overlapping with the seating portion.

18. The seat air conditioner according to claim 14, wherein
the through hole is open in a portion of the surface of the seat back, at an upper side with respect to a seating center line that is an imaginary line extending in a direction orthogonal to a vertical direction while passing through a midpoint in the vertical direction of the seating portion.

19. The seat air conditioner according to claim 14, wherein
the ventilation passage member forms an air flow passage through which the airflow flows to one side in a vertical direction as the predetermined direction,
when a center line is an imaginary line that extends in a direction orthogonal to the vertical direction while passing through a midpoint in the vertical direction of the surface of the seat back, the first ventilation port is an upper side ventilation port located on an upper side in the vertical direction of the surface of the seat back with respect to the center line, and
the second ventilation port is a lower side ventilation port located on a lower side in the vertical direction of the surface of the seat back with respect to the center line.

20. The seat air conditioner according to claim 19, wherein
an opening area of the upper side ventilation port is larger than an opening area of the lower side ventilation port.

21. The seat air conditioner according to claim 19, wherein
the upper side ventilation port is formed in a curved shape that extends downward in the vertical direction, from a center in a vehicle width direction as toward one side in the vehicle width direction of the ventilation passage member, and extends downward in the vertical direction, from the center in the vehicle width direction as toward the other side in the vehicle width direction of the ventilation passage member.

22. The seat air conditioner according to claim 21, wherein
the lower side ventilation port is formed in a curved shape that extends upward in the vertical direction, from the center in the vehicle width direction as toward one side in the vehicle width direction of the ventilation passage member, and extends upward in the vertical direction, from the center in the vehicle width direction as toward the other side in the vehicle width direction of the ventilation passage member.

23. The seat air conditioner according to claim 22, wherein
the upper side ventilation port and the lower side ventilation port are provided to satisfy a relationship of Lb<La, when
(i) a first reference line is an imaginary line that extends in the vehicle width direction while passing through an uppermost side in the vertical direction of the upper side ventilation port,
(ii) a second reference line is an imaginary line that extends in the vehicle width direction while passing through a lowermost side in the vertical direction of the upper side ventilation port,
(iii) La is a distance between the first reference line and the second reference line,
(iv) a third reference line is an imaginary line that extends in the vehicle width direction while passing through an uppermost side in the vertical direction of the lower side ventilation port, and
(v) a fourth reference line is an imaginary line that extends in the vehicle width direction while passing through a lowermost side in the vertical direction of the lower side ventilation port, and
(vi) Lb is a distance between the third reference line and the fourth reference line.

24. The seat air conditioner according to claim 1, wherein
the ventilation passage member forms a plurality of the air flow passages through which the airflow circulates along the surface.

25. The seat air conditioner according to claim 1, wherein
the first ventilation port and the second ventilation port are disposed such that the seating portion overlaps with a portion of the ventilation passage member located between the first ventilation port and the second ventilation port.
